(19) United States
(12) Patent Application Publication
(10) Pub. No.: US 2016/0366069 A1
(43) Pub. Date: Dec. 15, 2016

(54) COMMUNICATION DEVICE, COMMUNICATION SYSTEM, AND COMMUNICATION METHOD

(71) Applicant: Kabushiki Kaisha Toshiba, Minato-ku (JP)

(72) Inventors: Takeshi ISHIHARA, Yokohama (JP); Takahiro YAMAURA, Kawasaki (JP)

(73) Assignee: Kabushiki Kaisha Toshiba, Minato-ku (JP)

(21) Appl. No.: 14/946,932

(22) Filed: Nov. 20, 2015

(30) Foreign Application Priority Data
Jun. 9, 2015 (JP) 2015-116911

(51) Int. Cl. H04L 12/911; H04L 29/08

(52) U.S. Cl. CPC H04L 47/822; H04L 67/32

(57) ABSTRACT

According to an embodiment, a communication device is connectable to a portable terminal and a server. The device includes a wireless controller, a request processor, a determiner, a response generator, and a communication controller. The wireless controller is configured to control wireless communication with the terminal. The request processor is configured to receive a request to perform communication between the terminal and the server via the device. The request is transmitted from at least one of the terminal and the server. The determiner is configured to determine whether a resource required for the requested communication is allocatable. The response generator is configured to generate a response indicating a determination result. The communication controller is configured to store information received from one of the terminal and the server in a storage, and transmit information read from the storage to the other.

### CROSS-REFERENCE TO RELATED APPLICATION

This application is based upon and claims the benefit of priority from Japanese Patent Application No. 2015-116911, filed on Jun. 9, 2015; the entire contents of which are incorporated herein by reference.

### FIELD

Embodiments described herein relate generally to a communication device, a communication system, a communication method, a computer program product, and a terminal device.

### BACKGROUND

When a terminal device is in motion, the wireless communication performed by the terminal device is prone to become unstable. Hence, it is desirable that the communication is performed at high speeds over a short period of time to the extent possible. A technology is known in which the communication setup is cut down so as to achieve high-speed handover. For example, in the IEEE 802.11p standard, a method has been proposed for the purpose of omitting associations.

However, in the conventional technology, for example, no consideration is given to the manner of usage in which the information that is obtained from a terminal device in motion using wireless communication is further sent to a server device over the Internet. In such a manner of usage, the following issues arise, for example. A delay occurs due to the establishment of communication in the upper levels higher than the network layer, and a transmission delay occurs due to the use of the Internet.

### BRIEF DESCRIPTION OF THE DRAWINGS

FIG. 1 is a diagram illustrating an exemplary overall configuration of a communication system according to a first embodiment;

FIG. 2 is a diagram illustrating an exemplary hardware configuration of an access point (AP) and an in-vehicle device;

FIG. 3 is a diagram illustrating an exemplary hardware configuration of a server;

FIG. 4 is a block diagram illustrating an exemplary functional configuration of the AP;

FIG. 5 is a sequence diagram for explaining a communication operation according to the first embodiment;

FIG. 6 is a diagram illustrating an example of data transfer;

FIG. 7 is a diagram illustrating an example of performing scheduling;

FIGS. 8 and 9 are flowcharts for explaining examples of the communication operation;

FIGS. 10A and 10B are flowcharts for explaining a resource allocation operation;

FIG. 11 is a flowchart for explaining a communication operation performed with respect to the server;

FIGS. 12 and 13 are sequence diagrams for explaining the operations performed in response to receiving a preliminary setup request;

FIG. 14 is a sequence diagram for explaining operations performed when transmission information is received;

FIG. 15 is a sequence diagram for explaining an operation of uploading transmission information;

FIG. 16 is a diagram illustrating an exemplary overall configuration of a communication system according to a second embodiment;

FIG. 17 is a diagram illustrating an exemplary hardware configuration of an AP and an in-vehicle device;

FIG. 18 is a block diagram illustrating an exemplary functional configuration of the AP;

FIG. 19 is a sequence diagram for explaining a communication operation according to the second embodiment;

FIG. 20 is a diagram illustrating an exemplary overall configuration of a communication system according to a third embodiment;

FIG. 21 is a diagram illustrating an exemplary hardware configuration of an AP and an in-vehicle device;

FIG. 22 is a sequence diagram for explaining a communication operation according to the third embodiment;

FIG. 23 is a diagram illustrating an exemplary overall configuration of a communication system according to a fourth embodiment;

FIG. 24 is a diagram illustrating an exemplary hardware configuration of an AP and an in-vehicle device;

FIG. 25 is a diagram illustrating an overall configuration of a communication system according to a modification example;

FIG. 26 is a block diagram illustrating an exemplary functional configuration of the AP;

FIG. 27 is a sequence diagram for explaining a communication operation according to the fourth embodiment;

FIG. 28 is a sequence diagram for explaining a communication operation;

FIG. 29 is a flowchart for explaining the communication operation according to the fourth embodiment;

FIG. 30 is a flowchart for explaining a status determination operation;

FIG. 31 is a flowchart for explaining a determination operation;

FIG. 32 is a diagram illustrating an example of transfer destination information;

FIG. 33 is a flowchart for explaining a resource allocation operation;

FIG. 34 is a diagram illustrating an exemplary overall configuration of a communication system according to a fifth embodiment;

FIG. 35 is a diagram illustrating an exemplary hardware configuration of an in-vehicle device;

FIG. 36 is a diagram illustrating an overall configuration of a communication system according to a modification example;

FIG. 37 is a diagram illustrating an exemplary hardware configuration of an in-vehicle device;

FIG. 38 is a diagram illustrating an overall configuration of a communication system according to a modification example;

FIG. 39 is a diagram illustrating an exemplary hardware configuration of an in-vehicle device;

FIG. 40 is a diagram illustrating an overall configuration of a communication system according to a modification example;

FIG. 41 is a diagram illustrating an exemplary hardware configuration of an in-vehicle device;

FIG. 42 is a block diagram illustrating an exemplary functional configuration of the in-vehicle device;

FIGS. 43 and 44 are sequence diagrams for explaining a communication operation performed by the in-vehicle device according to the fifth embodiment;

FIGS. 45 and 46 are diagrams illustrating exemplary overall configurations of a communication system according to a sixth embodiment;

FIGS. 47 and 48 are sequence diagrams for explaining a communication operation according to the sixth embodiment;

FIG. 49 is a flowchart for explaining a communication operation performed by an in-vehicle device according to the sixth embodiment; and

FIG. 50 is a flowchart for explaining a communication operation performed by the AP according to the sixth embodiment.

### DETAILED DESCRIPTION

According to an embodiment, a communication device is connectable to a portable terminal device and a server device. The communication device includes a storage, a wireless communication controller, a request processor, a determiner, a response generator, and a communication controller. The storage is configured to store information transmitted and received between the terminal device and the server device. The wireless communication controller is configured to control wireless communication with the terminal device. The request processor is configured to receive a request to perform communication between the terminal device and the server device via the communication device. The request is transmitted from at least one of the terminal device and the server device. The determiner is configured to determine whether a resource required for the requested communication is allocatable. The response generator is configured to generate a response indicating a determination result obtained by the determiner. The communication controller is configured to store information received from one of the terminal device and the server device in the storage, and transmit information read from the storage to the other device.

Exemplary embodiments of a communication device, a communication system, a communication method, and a computer program product are described below in detail with reference to the accompanying drawings.

### First Embodiment

In a communication system according to a first embodiment, a communication device is used to relay the communication between a terminal device, which is portable in nature and capable of performing wireless communication, and a server device. The following explanation is given for an exemplary configuration in which the terminal device is an in-vehicle device and the communication device is an access point (AP) for wireless communication. However, the terminal device and the communication device are not limited to this example.

The AP determines, during a preliminary setup, whether the resources required for communication between an in-vehicle device and the AP as well as the resources required for communication between the AP and a server can be allocated, and sends the determination result to the source that issued a communication request. When it is determined that the resources can be allocated, the AP allocates the resources and relays the communication between the in-vehicle device and the server. Examples of resources include the communication channel for each type of communication (i.e., communication resources), the authority to communicate using the communication channels (authority resources), and storage areas such as a storage in the AP (storage area resources). Besides, any other type of resources can also be taken into account. For example, the authority to use resources other than the communication channels can also be treated as a resource.

With such a configuration, communication can be performed when the resources enabling communication with the desired quality can be allocated. As a result, communication among the terminal device, the communication device, and the server device can be performed in a more stable manner.

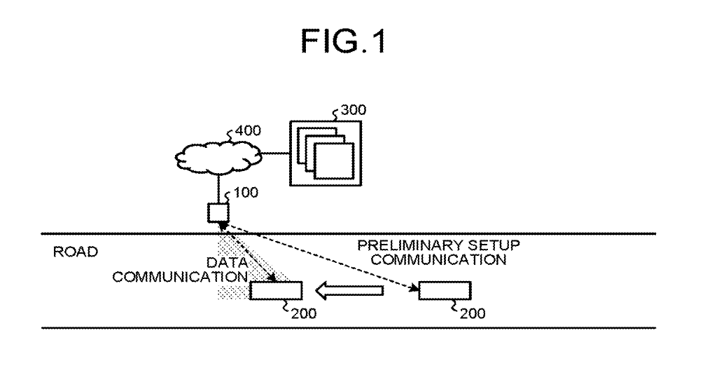

FIG. 1 is a diagram illustrating an exemplary overall configuration of the communication system according to the first embodiment. As illustrated in FIG. 1, the communication system according to the first embodiment includes an AP 100, an in-vehicle device 200, a server 300, and a network 400. Herein, each device (i.e., the AP 100, the in-vehicle device 200, and the server 300) can be more than one in number. Regarding all other embodiments too, the same is true.

The network 400 establishes connection between the AP 100 and the server 300. Herein, the network 400 is configured using the Internet, for example.

The AP 100 is a communication device capable of performing wireless communication with the in-vehicle device 200. For example, the AP 100 can be implemented as a roadside device (as an ITS spot (ITS stands for Intelligent Transport System)) installed on the side of a road through which a vehicle (a mobile object) equipped with the in-vehicle device 200 passes.

The in-vehicle device 200 is installed in a vehicle such as an automobile, and has the function of performing wireless communication via the AP 100.

The server 300 has the function of receiving and processing the information sent from the in-vehicle device 200, and has the function of sending information to the in-vehicle device 200. The server 300 can be a device of any type. For example, the server 300 can be a server for receiving and managing the contents sent from the in-vehicle device 200, or can be a server for delivering the contents managed therein to the in-vehicle device 200.

As illustrated in FIG. 1, when approaching the AP 100, the in-vehicle device 200 performs communication with the AP 100 for the purpose of preliminary setup (preliminary setup communication). Once the resources are allocated during the preliminary setup communication, the in-vehicle device 200 sends information to the AP 100. Then, the AP 100 sends the information, which is received from the in-vehicle device 200, to the server 300 at an arbitrary timing.

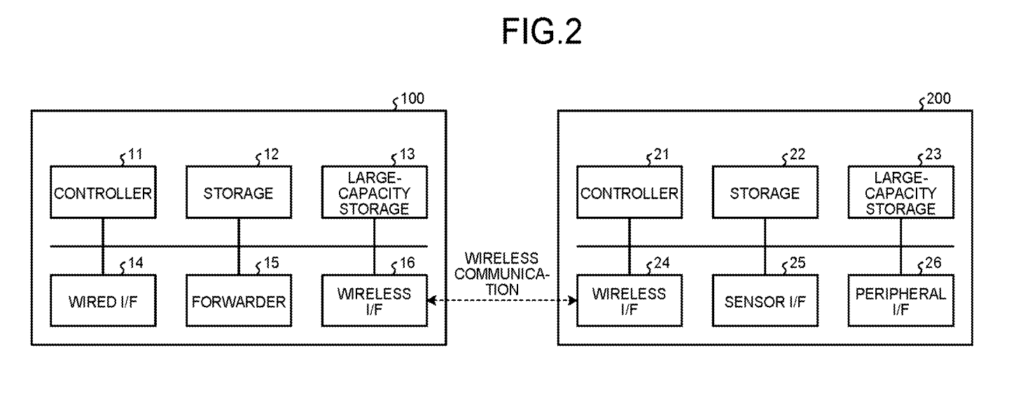

FIG. 2 is a diagram illustrating an exemplary hardware configuration of the AP 100 and the in-vehicle device 200. As illustrated in FIG. 2, the AP 100 includes a controller 11, a storage 12, a large-capacity storage 13, a wired interface (I/F) 14, a forwarder 15, and a wireless I/F 16.

The controller 11 controls the operations of the AP 100 in entirety. Herein, the controller 11 is configured using a central processing unit (CPU), for example.

The storage 12 is used to store a variety of information used during the operations performed in the AP 100. For example, the storage 12 is used as a working memory for the computer programs running in the controller 11, and is used as a buffer when information is exchanged among various constituent elements. Herein, the storage 12 is configured using a storage medium such as a synchronous dynamic random access memory (SDRAM).

The large-capacity storage 13 is configured using a storage medium such as a solid state drive (SSD), a hard disk drive (HDD), or a NAND-type flash memory. The large-capacity storage 13 is used, for example, to temporarily store the information specified in a request for preliminary setup (a preliminary setup request).

Meanwhile, the configuration of the storage 12 and the configuration of the large-capacity storage 13 are only exemplary, and any other commonly-used storage medium can be alternatively used.

The wired I/F 14 is an interface for performing wired communication via the network 400. For example, the wired I/F 14 is a communication interface assumed to be connected with a backhaul line for establishing connection with the Internet.

The wireless I/F 16 is an interface for performing wireless communication with the in-vehicle device 200. For example, the wireless I/F 16 can be an interface based on a standard such as IEEE 802.11a/b/g/n/ac that is primarily considered for high-speed data communication. Alternatively, the wireless I/F 16 can be an interface such as IEEE 802.11p that is considered for use in the intelligent transport system (ITS).

The forwarder 15 controls the transfer of information among the constituent elements. For example, the forwarder 15 performs a bridge operation between the wired I/F 14 and the wireless I/F 16, and transfers frames. Moreover, from the frames received from outside, the forwarder 15 extracts frames to be processed using the functions of the controller 11 and transfers the frames to the respective functions. Furthermore, the forwarder 15 performs control so that the frames sent from the functions implemented by the controller 11 are sent via appropriate interfaces.

Given below is the explanation of a hardware configuration of the in-vehicle device 200. As illustrated in FIG. 2, the in-vehicle device 200 includes a controller 21, a storage 22, a large-capacity storage 23, a wireless I/F 24, a sensor I/F 25, and a peripheral I/F 26.

The controller 21, the storage 22, the large-capacity storage 23, and the wireless I/F 24 can have an identical configuration to the controller 11, the storage 12, the large-capacity storage 13, and the wireless I/F 16, respectively, of the AP 100.

The sensor I/F 25 is an interface for establishing connection with various sensors installed in a vehicle. Examples of the sensors include an acceleration sensor for detecting the acceleration of the vehicle, a thermo-hygro sensor for detecting the temperature and the humidity, an illuminance sensor for detecting the brightness, and an infrared sensor for detecting the situation around the vehicle. The peripheral I/F 26 is an interface for establishing connection with peripheral devices, and has an in-vehicle camera connected thereto. Meanwhile, although such sensors and peripheral devices can be directly connected to the in-vehicle device 200 via the interfaces illustrated in FIG. 2, the sensors and the peripheral devices can alternatively be connected to the in-vehicle device 200 via a different in-vehicle system using an inter-system connection interface (such as CAN, FlexRay, or in-vehicle Ethernet (registered trademark)).

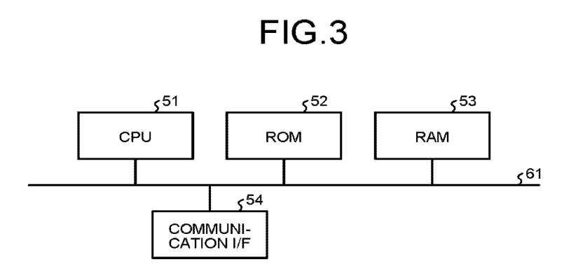

FIG. 3 is a diagram illustrating an exemplary hardware configuration of the server 300. As illustrated in FIG. 3, the server 300 includes a control device such as a CPU 51, storage devices such as a read only memory (ROM) 52 and a random access memory (RAM) 53, a communication I/F 54 that performs communication by establishing connection with a network, and a bus 61 that interconnects the other constituent elements.

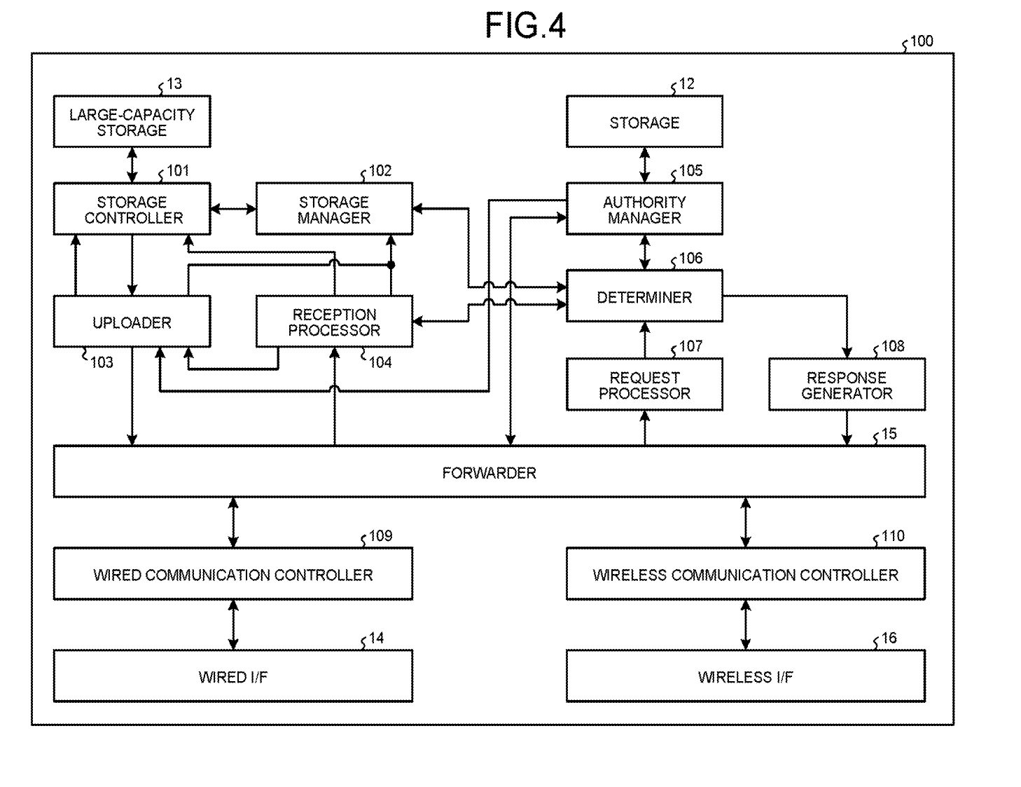

Given below is the explanation of an exemplary functional configuration of the AP 100. FIG. 4 is a block diagram illustrating an exemplary functional configuration of the AP 100. As illustrated in FIG. 4, in addition to including the storage 12, the large-capacity storage 13, the wired I/F 14, the forwarder 15, and the wireless I/F 16; the AP 100 also includes a storage controller 101, a storage manager 102, an uploader 103, a reception processor 104, an authority manager 105, a determiner 106, a request processor 107, a response generator 108, a wired communication controller 109, and a wireless communication controller 110.

Herein, for example, the storage controller 101, the storage manager 102, the uploader 103, the reception processor 104, the authority manager 105, the determiner 106, the request processor 107, the response generator 108, the wired communication controller 109, and the wireless communication controller 110 can be implemented by executing computer programs in the CPU 51, that is, can be implemented using software; or can be implemented using hardware such as an integrated circuit (IC); or can be implemented using a combination of software and hardware.

Moreover, some or all of the functions of the forwarder 15 can be implemented using software in the CPU 51.

The storage controller 101 accesses the storage (the storage 12 and the large-capacity storage 13). The storage controller 101 can be implemented in the form of a device driver.

The storage manager 102 manages the storage. For example, the storage manager 102 manages the capacity (the used capacity and the available capacity; hereinafter, called storage capacity) of the large-capacity storage 13. The information about the managed storage capacity is stored in the storage 12, for example.

The uploader 103 uploads the received information to the server 300.

The reception processor 104 controls the reception of a variety of information. For example, the reception processor 104 receives information that is notified during the preliminary setup. Regarding whether or not the setup is already performed, the reception processor 104 confirms using the determiner 106. In the case in which the timing for sending or receiving the notified information is to be determined by means of polling, the reception processor 104 manages the timing.

The received information is stored in the large-capacity storage 13 via the storage controller 101. The used capacity of the large-capacity storage 13 is notified to the storage manager 102 and is used in managing the storage capacity.

The authority manager 105 manages the authority for sending the information, which is temporarily stored upon being received from the sender of the preliminary setup request, as legitimate information from the AP 100. The authority manager 105 communicates with the information provider and the information destination, and receives delegation of authority. Herein, for example, authority information is stored and managed in the storage 12. Alternatively, a dedicated storage can be provided so as to ensure that the authority information cannot be referred to from the other constituent elements.

The determiner 106 determines whether or not necessary resources can be allocated to the requested communication. For example, the determiner 106 determines whether or not it is possible to allocate the resources related to the target information for uploading that is specified in the preliminary setup request. The determiner 106 confirms the storage capacity with the storage manager 102, and confirms the authority with the authority manager 105. As far as the communication resources are concerned, it is the determiner 106 that performs determination. The usage status of the communication resources is stored in the storage 12, for example.

The request processor 107 processes various requests that are received. For example, the request processor 107 receives and processes a preliminary setup request. Unless the request message has any issue such as an improper format, the request processor 107 turns over the processing to the determiner 106 and instructs the determiner 106 to determine whether or not the resources can be allocated.

The response generator 108 generates and outputs a response to a request. For example, with respect to the preliminary setup request, the response generator 108 generates a response representing the determination result of the determiner 106; and sends the response to the sender of the preliminary setup request.

The wired communication controller 109 controls the relay between the wired I/F 14 and the forwarder 15. For example, the wired communication controller 109 is implemented using a device driver or firmware.

The wireless communication controller 110 controls the wireless communication with the in-vehicle device 200. For example, the wireless communication controller 110 controls the relay between the wireless I/F 16 and the forwarder 15. For example, the wireless communication controller 110 is implemented using a device driver or firmware.

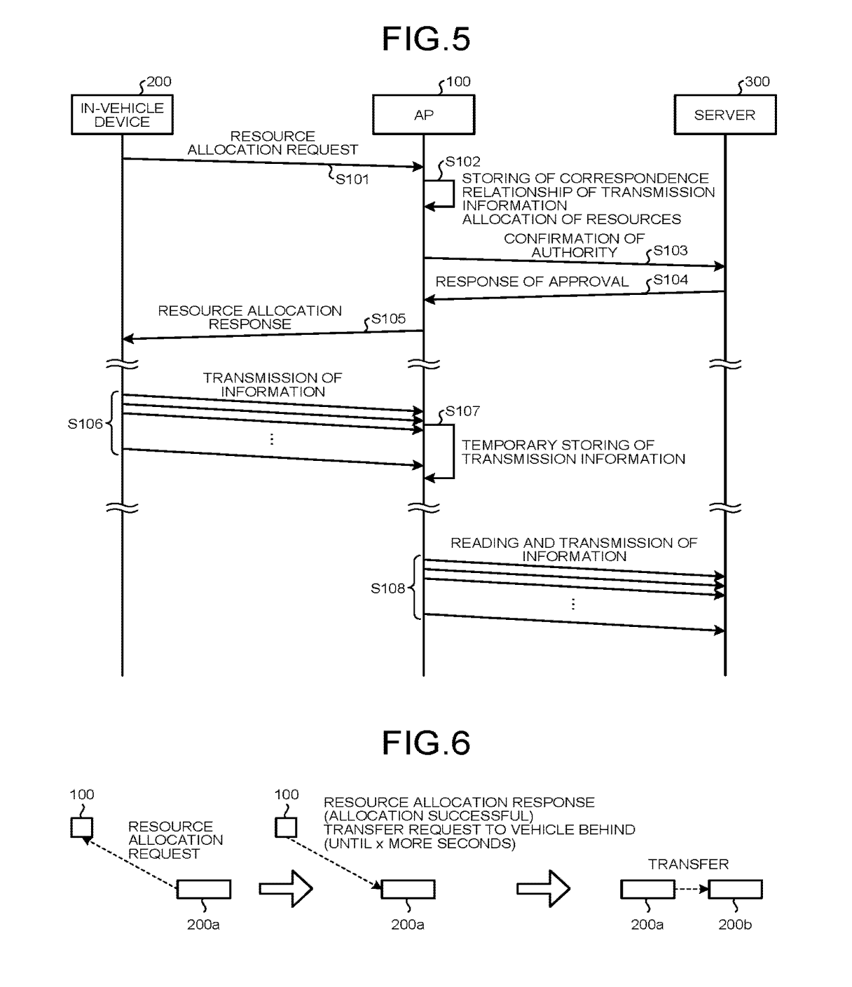

Explained below with reference to FIG. 5 is a communication operation performed by the AP 100 configured in the abovementioned manner according to the first embodiment. FIG. 5 is a sequence diagram for explaining an example of the communication operation according to the first embodiment.

The in-vehicle device 200 sends a preliminary setup request to the AP 100 (Step S101). In the first embodiment, since determination and allocation of resources is performed with respect to the preliminary setup request, it is sometimes called a resource allocation request in the following explanation.

The preliminary setup request includes, for example, the characteristics of transmission information, authority information, and the final destination of transmission information. Herein, transmission information indicates the information to be uploaded (sent) from the in-vehicle device 200 to the server 300. The characteristics of transmission information represent, for example, the size, the priority (the degree of importance), and the format. The transmission destination can be the address of the server 300, or the communication protocol that is used, or a uniform resource identifier (URI) having the address and the communication protocol, or a name of a location of storage, or a name of information.

Upon receiving the preliminary setup request, the AP 100 stores the correspondence relationship of the transmission information in the large-capacity storage 13, and determines whether or not resources can be allocated (Step S102).

The correspondence relationship represents information in which, for example, identification of the in-vehicle device 200 that issued the request, the transmission destination of the transmission information, and characteristics information of the transmission information is held in a corresponding manner.

In the case of using authority resources as the resources, the authority manager 105 confirms the authority with the server 300 (Step S103). Herein, confirmation of the authority with the server 300 can be done according to any arbitrary method. For example, it is possible to implement a protocol such as OAuth. Depending on the implemented protocol, the necessary information can be appropriately exchanged not only between the AP 100 and the server 300 but also among the AP 100, the server 300, and the in-vehicle device 200. Then, the server 300 sends an authority confirmation response to the AP 100 (Step S104).

When it is determined that the resources can be allocated, the AP 100 allocates the resources and sends a response including the determination result (i.e., sends a preliminary setup response) to the in-vehicle device 200 (Step S105). Meanwhile, if the transmission information needs to be sent using a special means (such as a different channel or a different communication protocol), then the information required to use the special means can be included in the preliminary setup response.

The in-vehicle device 200 starts sending the transmission information using the resources (such as a wireless communication channel and a storage area of the storage) allocated with the AP 100 (Step S106). Then, the AP 100 temporarily stores the transmission information in the storage (Step S107). At that point of time, since the transmission information need not be sent to the server 300, the AP 100 can store the transmission information in its own storage (such as the large-capacity storage 13) at a fast rate.

Subsequently, the AP 100 reads the stored transmission information at an arbitrary timing, and sends it to the server 300 representing the transmission destination specified in the preliminary setup request (Step S108). Herein, the AP 100 can send the transmission information by a transmission deadline set during the setup.

Meanwhile, when it is determined at Step S102 that the resources cannot be allocated, following various actions can be taken.

(1) a response indicating an error is sent back.
(2) when there is no free space available in the storage in the AP 100
(2-1) by taking into account the fact that free space may again become available due to operations for sending some other information to the server 300, the time period for securing the storage space is estimated and a response indicating the time at which transmission becomes possible (i.e., a response indicating the time at which a storage area can be allocated) is sent back. The time at which transmission becomes possible implies the time at which the in-vehicle device 200 representing the sender of information becomes able to send the information. Moreover, in other words, the time at which transmission becomes possible can be said to be the time at which the AP 100 can receive the information.
(2-2) other transmission information having a lower priority than the requested transmission information is deleted so as to allocate the storage capacity, and then a response is sent back.
(3) a response including identification information of other APs 100 is sent back. For example, an inquiry about the AP 100 that can send the transmission information is made to the server 300 or the other APs 100, and a response including identification information of the AP 100 that replied can be sent back. The identification information of the other APs 100 can be determined according to an arbitrary method. In that case, for example, when a resource allocation request is received, each other AP 100 can further determine whether the resources can be allocated therein.
(4) the in-vehicle device 200 representing the sender is requested to perform a preliminary operation with respect to the transmission information. For example, the concerned in-vehicle device 200 can be requested to perform an operation for reducing the size of the transmission information (an operation for compressing the transmission information or an operation for taking the average value of data).

Meanwhile, the preliminary operation can also be performed in a case other than the case of not being able to allocate the resources. If the size decreases, communication can be completed faster thereby increasing the possibility of being able to send the information. Moreover, the preliminary operation is not limited to the operation of reducing the size. Alternatively, for example, if the information is reusable in other in-vehicle devices 200, an operation for processing the information into an easier-to-reuse form can be performed in advance. The preliminary operation can be performed in response to a request from the AP 100, or can be performed by the in-vehicle device 200 regardless of whether a request is received. As far as image processing is concerned, for example, instead of sending the image captured by the in-vehicle camera without modification, the result of recognition performed with respect to the image can be sent.

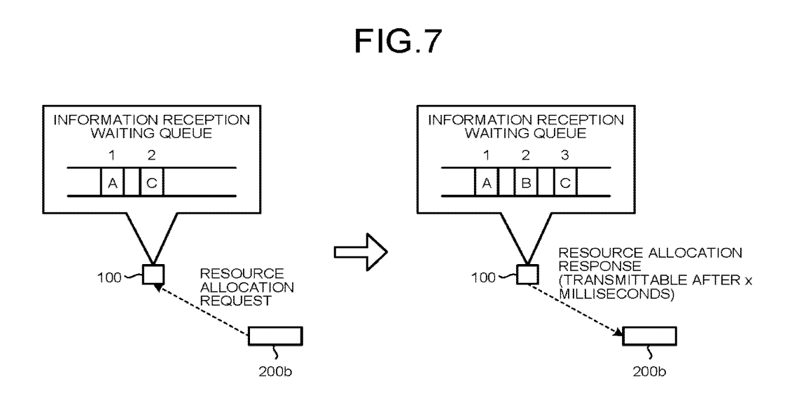

In the case of a communication protocol such as IEEE 802.11p in which inter-vehicle communication is taken into account, the AP 100 can request the in-vehicle device 200 to transfer data to the vehicle behind. For example, the AP 100 can request the in-vehicle device 200 to transfer the reusable information to the vehicle behind. FIG. 6 is a diagram illustrating an example of data transfer in such a configuration.

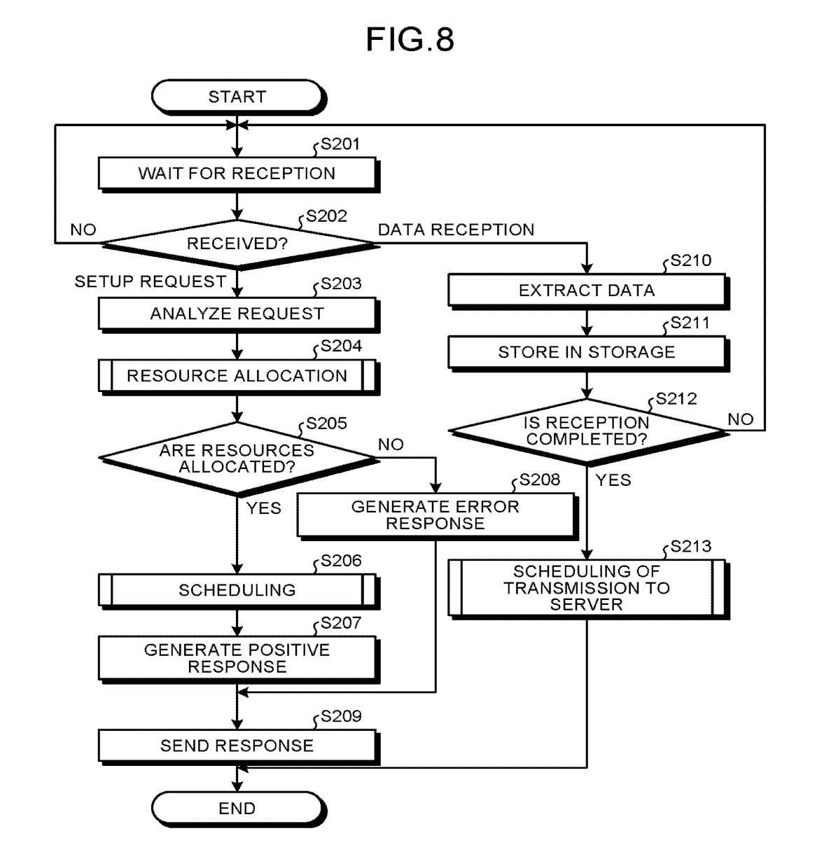

Examples of the reusable information include accident information and traffic jam information in addition to the recognition result explained earlier. In the case of requesting the transfer, it is also possible to notify the time period for attempting the transfer. In FIG. 6 is illustrated an example in which an in-vehicle device 200a is requested to transfer data “until x more seconds” to an in-vehicle device 200b that is behind the in-vehicle device 200b. Meanwhile, in addition to securing the resources, the AP 100 can also perform scheduling. FIG. 7 is a diagram illustrating an example of performing scheduling.

In the example illustrated in FIG. 7, firstly, the in-vehicle device 200b sends a resource allocation request to the AP 100. Herein, the AP 100 manages waiting for transmission of the transmission information from the in-vehicle device 200b in a queue provided in the storage 12, for example. In this example, transmission information A and transmission information C requested from other in-vehicle devices 200 are awaited. The transmission information A and the transmission information C are scheduled to be sent in that order (transmission order of 1 and 2). Then, the AP 100 schedules the transmission of transmission information B requested by the in-vehicle device 200b. In this example, the transmission information B is scheduled to be sent in between the transmission of the transmission information A and the transmission of the transmission information C.

The AP 100 can perform scheduling by taking into account the priority. As a result of the scheduling, the transfer start time can be notified during the response. For example, information such as “start of transfer after x milliseconds” can be included in the response and sent to the in-vehicle device 200b. At that time, the fact that transmission of the already-queued transmission information may or may not be notified to the source that issued a request for the concerned transmission information. Since the transmission timing is controlled, the transmission information can be subjected to polling from the AP 100. The transfer of transmission information can be started from the in-vehicle device 200 in a self-managed timing.

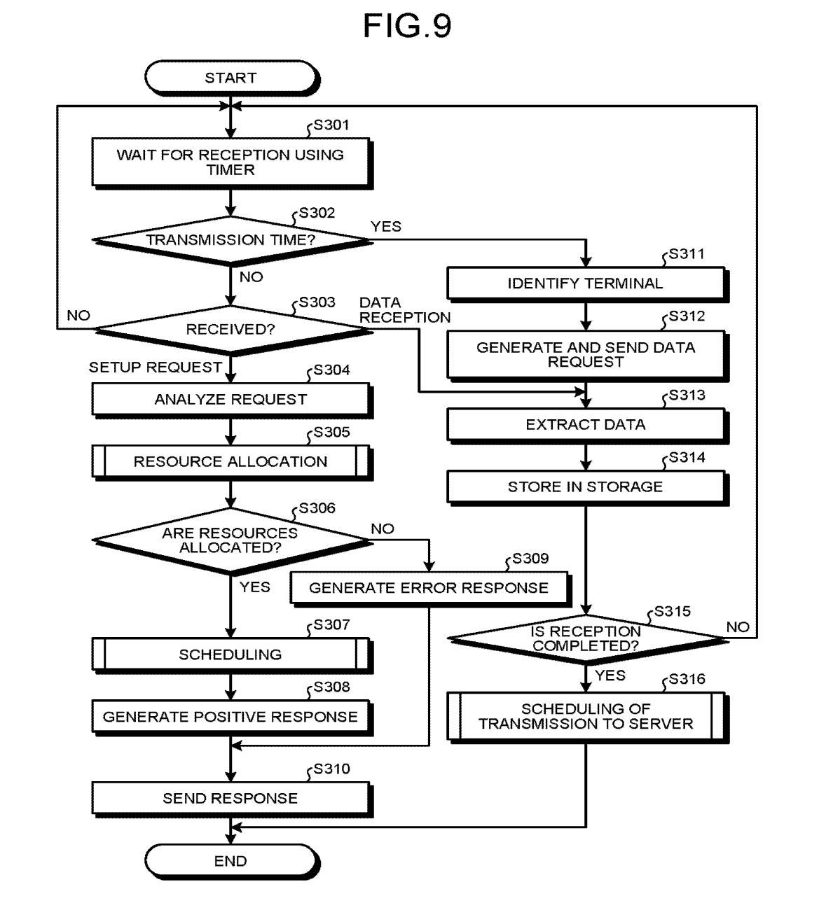

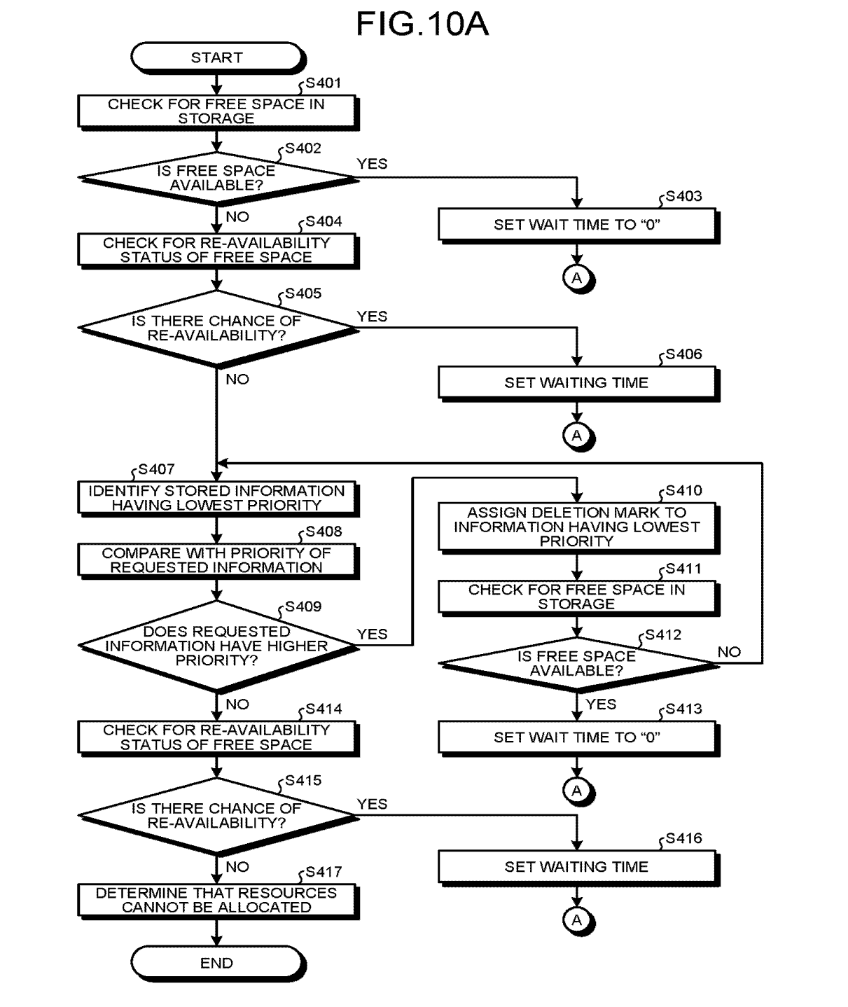

Explained below with reference to FIGS. 8 and 9 are the details of the communication operation. FIGS. 8 and 9 are flowcharts for explaining examples of the communication operation. In FIG. 8 is illustrated an example in which the transmission information is sent from the in-vehicle device 200. In FIG. 9 is illustrated an example in which the transmission information is subjected to polling from the AP 100.

In the AP 100, the request processor 107 waits for the reception of a preliminary setup request and the reception processor 104 waits for the reception of transmission information (Step S201). The forwarder 15 analyzes the communication protocol of the received packet, the IP address of the received packet, the port number of the received packet, and the message body as may be necessary; and determines whether or not a preliminary setup request or a transmission request for sending transmission information is received (Step S202). If a preliminary setup request or a transmission request is not received (No at Step S202), then the forwarder 15 waits until a request is received.

When a preliminary setup request is received (setup request at Step S202), the request processor 107 analyzes the preliminary setup request (Step S203). For example, the request processor 107 extracts the transmission destination of the transmission information from the preliminary setup request, and generates and stores information indicating the correspondence relationship.

The determiner 106 performs a resource allocation operation for determining whether or not the resources can be allocated (Step S204). The detailed explanation of the resource allocation operation is given later.

Once the resources are allocated (Yes at Step S205), the determiner 106 performs scheduling to determine the transmission timing of the transmission information (Step S206). The scheduling is performed according to the method explained with reference to FIG. 7, for example. Meanwhile, even a simple first in first out (FIFO) management is treated herein as scheduling.

The response generator 108 generates a response indicating that the resources could be allocated (i.e., generates a positive response) (Step S207). As described above, the response may include the transfer start time representing the result of scheduling. Moreover, the response generator 108 can generate a response for requesting transfer of reusable information to the vehicle behind.

If the resources cannot be allocated (No at Step S205), the response generator 108 generates a response (an error response) indicating that the resources cannot be allocated (Step S208). Moreover, the response generator 108 can generate a response for requesting a preliminary operation with respect to the transmission information. The request processor 107 sends the generated response to the in-vehicle device 200 via the forwarder 15, the wireless communication controller 110, and the wireless I/F 16 (Step S209).

Meanwhile, at Step S202, when a transmission request for sending transmission information is received (data reception at Step S202), the reception processor 104 extracts transmission information from the received transmission request (Step S210). Then, the reception processor 104 stores the extracted transmission information in the storage (Step S211). Moreover, the reception processor 104 determines whether or not all sets of transmission information have been received (Step S212). If all sets of transmission information have not been received (No at Step S212), the system control returns to Step S201 and the operations are repeated.

When all sets of transmission information are received (Yes at Step S212), the determiner 106 schedules the transmission of the transmission information to the server 300 (Step S213). Herein, the scheduling can be performed according to any arbitrary method. For example, the transmission timings can be determined by referring to the priorities or to the transmission completion timings notified during the preliminary setup communication.

In FIG. 9 is illustrated an example in which the transmission information is subjected to polling from the AP 100.

In the AP 100, the request processor 107 waits for the reception of a preliminary setup request and the reception processor 104 waits for the reception of transmission information. The reception processor 104 waits until the scheduled transmission time using a timer (Step S301). Moreover, the reception processor 104 determines whether or not it is the transmission time (Step S302).

When it is the transmission time (Yes at Step S302), the reception processor 104 identifies the in-vehicle device 200 representing the sender of transmission information (Step S311). The reception processor 104 generates a data request for requesting transmission of transmission information, and sends the data request to the identified in-vehicle device 200 (Step S312).

However, until it is the transmission time (No at Step S302), the reception processor 104 determines whether or not a preliminary setup request or a transmission request for sending transmission information is received (Step S303). If no request is received (No at Step S303), the system control returns to Step S301 and the reception processor 104 continues to wait.

When the in-vehicle device 200 sends transmission information in response to the data request or when a transmission request for sending transmission information is received at Step S303 (data reception at Step S303), the reception processor 104 extracts the transmission information from the received transmission request (Step S313).

The subsequent operations from Steps S314 to S316 are identical to the operations from Steps S211 to S213 explained with reference to FIG. 8. Hence, the explanation is not repeated. Meanwhile, at Step S303, if it is determined that a preliminary setup request is received (setup request at Step S303), operations from Steps S304 to S310 are performed in an identical manner to the operations from Steps S203 to S209 explained with reference to FIG. 8.

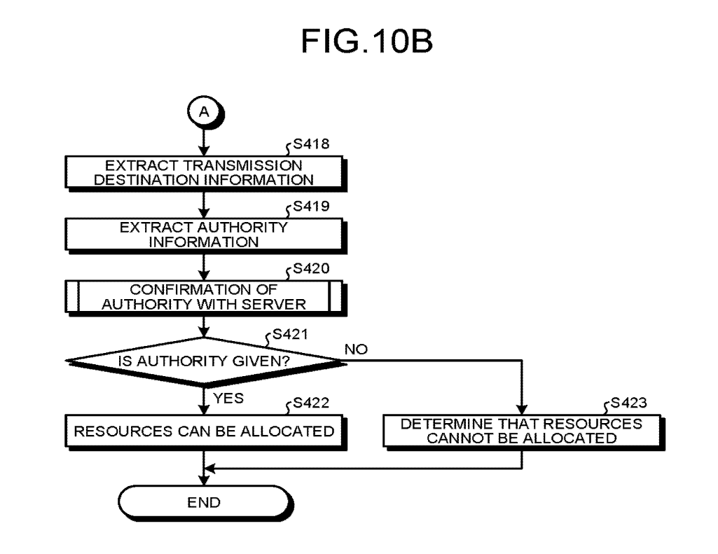

Given below is the detailed explanation of the resource allocation operation performed at Step S204. FIGS. 10A and 10B are flowcharts for explaining examples of the resource allocation operation.

The determiner 106 checks for the free space in the storage using the storage manager 102 (Step S401). Depending on the size of transmission information, the determiner 106 determines whether or not free space is available in the storage for the purpose of storing the transmission information (Step S402). If free space is available (Yes at Step S402), the determiner 106 sets the wait time to “0” (Step S403).

However, if free space is not available (No at Step S402), then the determiner 106 checks for the re-availability status of the free space (Step S404). For example, as explained earlier in (2-1), the determiner 106 checks whether free space would become available again due to the operations for sending some other information. The determiner 106 determines whether or not there is a chance of free space becoming available again (Step S405). If there is a chance of free space becoming available again (Yes at Step S405), then the determiner 106 sets the waiting time to wait for the free space becoming available again (Step S406). For example, the waiting time is set to be the period of time taken for completion of transmission of other information having the size equal to or greater than the size of the requested transmission information.

However, if there is no chance of free space becoming available again (No at Step S405), then the determiner 106 identifies the stored information having the lowest priority (Step S407). Herein, the stored information having the lowest priority implies the transmission information having the lowest priority from among the sets of currently-stored transmission information.

Then, the determiner 106 compares the priority of the requested transmission information with the priority of the identified transmission information (Step S408), and determines whether or not the requested transmission information has a higher priority (Step S409). If the requested transmission information has a higher priority (Yes at Step S409), then the determiner 106 assigns a deletion mark to the transmission information having the lowest priority (Step S410). Then, under the assumption that the transmission information assigned with the deletion mark is deleted, the determiner 106 again checks for the free space in the storage (Step S411).

The determiner 106 determines whether or not free space is available for the purpose of storing the transmission information (Step S412). If free space is available (Yes at Step S412), the determiner 106 sets the wait time to “0” (Step S413). However, if free space is not available (No at Step S412), the system control returns to Step S407 and the operations are repeated.

Meanwhile, at Step S409, if it is determined that the requested transmission information does not have a higher priority (No at Step S409); then, under the assumption that the transmission information assigned with the deletion mark is deleted, the determiner 106 again checks for the re-availability status of the free space (Step S414). If the determiner 106 determines whether or not there is a chance of free space becoming available again (Step S405). If there is a chance of free space becoming available again (Yes at Step S415), then the determiner 106 sets the waiting time to wait for the free space becoming available again (Step S416). However, if there is no chance of free space becoming available again (No at Step 3415), then the determiner 106 determines that the resources cannot be allocated (Step S417). That marks the end of the operations. Meanwhile, with reference to FIG. 9, although the explanation is given for a case in which the actions (1), (2-1), and (2-2) are taken, it is alternatively possible to take the action (1) only.

After setting the waiting time at Steps S403, S406, S413, and S416; the determiner 106 extracts information indicating the transmission destination from the preliminary setup request (Step S418). Moreover, the determiner 106 extracts authority information from the preliminary setup request (Step S419).

The determiner 106 confirms the authority with the server 300 indicated by the extracted destination information (Step S420). The determiner 106 determines whether or not authority is given (Step S421). If authority is given (Yes at Step S421), then the determiner 106 determines that the resources can be allocated (Step S422). However, if authority is not given (No at Step S421), then the determiner 106 determines that the resources cannot be allocated (Step S423). That marks the end of the operations.

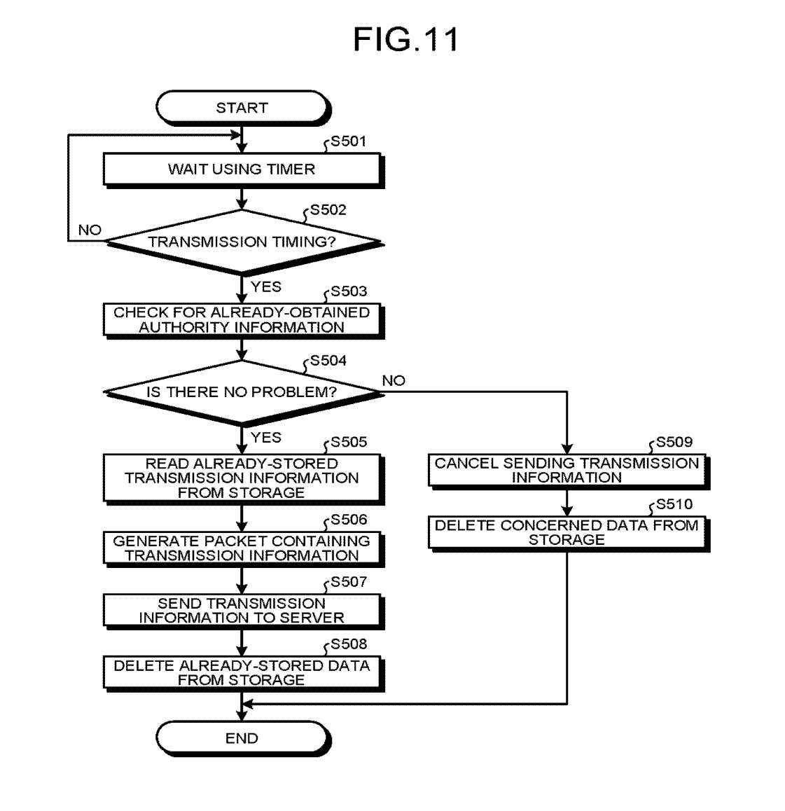

Given below is the detailed explanation of a transmission operation for sending transmission information to the server 300 according to the scheduling performed at Step S213. FIG. 11 is a flowchart for explaining an example of the communication operation for sending transmission information to the server 300.

The uploader 103 waits until the scheduled transmission timing using a timer (Step S501). Then, the uploader 103 determines whether or not it is the transmission timing (Step S502). If it is not the transmission timing (No at Step S502), the uploader 103 waits till the transmission timing.

When it is the transmission timing (Yes at Step S502), the uploader 103 checks for the already-obtained authority information (Step S503) and determines whether or not there is no problem in the authority information (Step S504). If there is any problem in the authority information (No at Step S504), then the uploader 103 cancels sending the concerned transmission information (Step S509) and deletes that transmission information from the storage (Step S510). At that time, information indicating that the information from the in-vehicle device 200 could not be sent can be sent to the server 300 regardless of the presence or absence of the authority information.

If there is no problem (Yes at Step S504), then the uploader 103 makes use of the storage controller 101 and reads the already-stored transmission information from the storage (Step S505). Then, the uploader 103 generates a packet containing the transmission information (Step S506); and sends the packet to the server 300 via the forwarder 15, the wired communication controller 109, and the wired I/F 14 (Step S507). Moreover, the uploader 103 makes use of the storage controller 101 and deletes the sent transmission information from the storage (Step S508).

For example, due to aberrance in the authority information or due to network malfunctioning, there may be times when the temporarily-stored transmission information cannot be sent to the server 300. In the earlier explanation of the flowcharts, the transmission is cancelled when there is aberrance in the authority information. However, the handling in case of malfunctioning is not limited to that case. Alternatively, for example, the configuration can be such that, when there is a trouble regarding the authority, it is obtained again. However, in order to obtain the authority, it is necessary to communicate with the sender terminal device (the in-vehicle device 200). Thus, if that terminal device is not present in the communication range of the AP 100, then the transfer of authority may not be done in a correct manner. In the case of network malfunctioning, after the elapse of a predetermined period of time, transmission can be reattempted. In that case, the upper limit for the number of reattempts can be set.

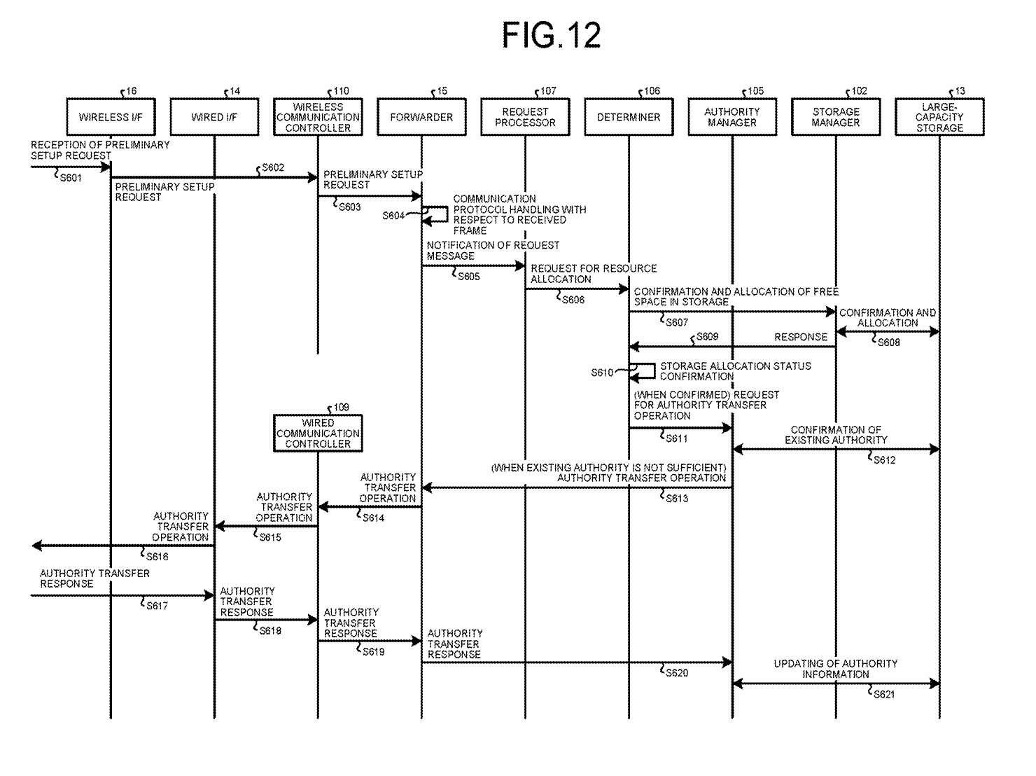

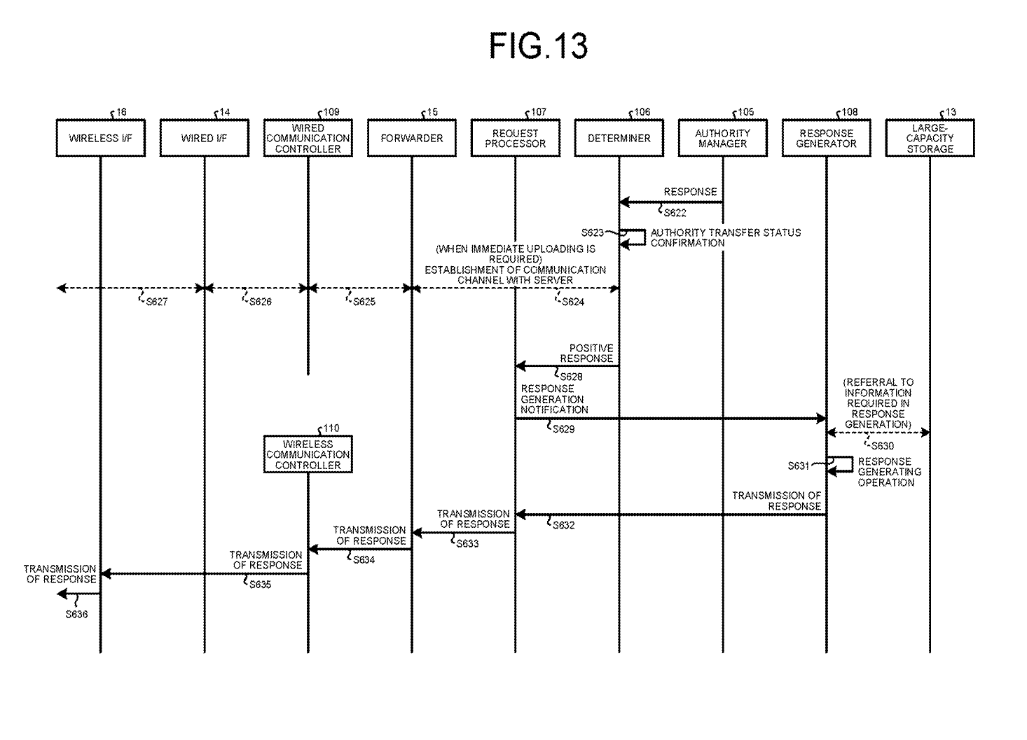

Given below is further explanation about the operations performed by the AP 100 in response to receiving a preliminary setup request. FIGS. 12 and 13 are sequence diagrams for explaining the operations performed in response to receiving a preliminary setup request.

Upon receiving the preliminary setup request (Step S601), the wireless I/F 16 sends the preliminary setup request to the forwarder 15 via the wireless communication controller 110 (Steps S602 and S603). Then, the forwarder 15 performs communication protocol handling with respect to the received frame (Step S604). The forwarder 15 sends to the request processor 107 a request message for requesting the processing of the preliminary setup request (Step S605). The request processor 107 requests the determiner 106 to allocate the resources (Step S606).

The determiner 106 requests the storage manager 102 to check for free space in the storage and allocate a storage area (Step S607). The storage manager 102 checks for free space in the large-capacity storage 13 and allocates a storage area as may be necessary (Step S608). Then, the storage manager 102 sends back a checking/allocation result to the determiner 106 (Step S609).

The determiner 106 refers to the reply and confirms the storage allocation status (Step S610). If a storage area in the storage has been allocated, then the determiner 106 requests the authority manager 105 to perform an authority transfer operation (Step S611). The authority manager 105 refers to the large-capacity storage 13 (or the storage 12) and confirms about the presence or absence of the existing authority (Step S612).

If the existing authority is not sufficient, then the authority manager 105 performs an authority transfer operation with the server 300. Herein, the authority transfer operation is performed with the server 300 via the forwarder 15, the wired communication controller 109, and the wired I/F 14 (Steps S613 to S616). Then, the server 300 sends a response with response to the authority transfer operation (Steps S617 to S620). Then, the authority manager 105 updates the authority information stored in the large-capacity storage 13 (Step S621).

The authority manager 105 sends the result of the authority transfer operation to the determiner 106 (Step S622). The determiner 106 refers to the response from the authority manager 105 and confirms the status of authority transfer (Step S623). Based on an uploading limit specified in the preliminary setup request, if immediate uploading is required, the determiner 106 establishes a communication channel with the server 300 (Steps S624 to S627).

When the resources can be allocated, the determiner 106 sends a determination result, which indicates that the resources can be allocated, to the request processor 107 (Step S628). Then, the request processor 107 requests the response generator 108 to generate a response (Step S629).

The response generator 108 reads, from the large-capacity storage 13, information required in generating a response as may be necessary (Step 3630). Then, the response generator 108 performs a response generating operation (Step S631).

The response generator 108 sends the generated response to the source of request via the request processor 107, the forwarder 15, the wireless communication controller 110, and the wireless I/F 16 (Steps S632 to S636).

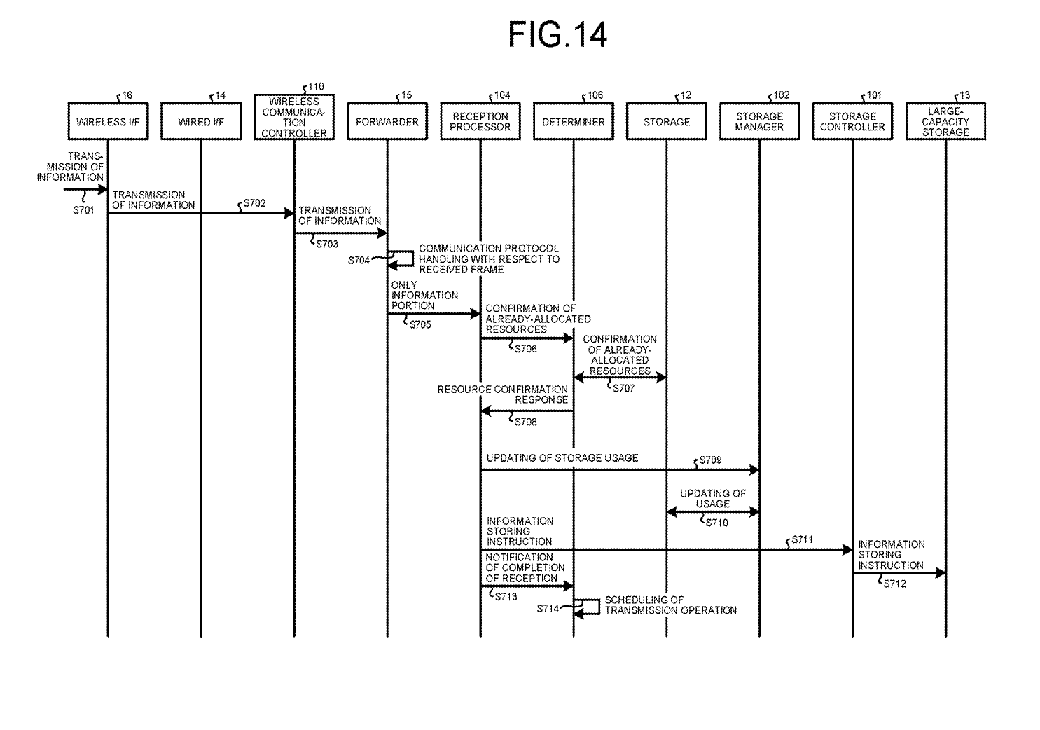

Given below is further explanation of the operations performed by the AP 100 when transmission information is received from the in-vehicle device 200. FIG. 14 is a sequence diagram for explaining the operations performed when transmission information is received.

Upon receiving a transmission request for sending transmission information (Step S701), the wireless I/F 16 sends the transmission request to the forwarder 15 via the wireless communication controller 110 (Steps S702 and S703). Then, the forwarder 15 performs communication protocol handling with respect to the received frame (Step S704). The forwarder 15 notifies the reception processor 104 about the requested transmission information (Step S705). The reception processor 104 requests the determiner 106 to check for the already-allocated resources (Step S706).

The determiner 106 refers to the storage 12 and checks for the already-allocated resources (Step S707). Then, the determiner 106 sends the confirmation result to the reception processor 104 (Step S708).

The reception processor 104 requests the storage manager 102 to update the storage usage (Step S709). In response, the storage manager 102 updates the storage usage of the storage 12 (Step S710).

The reception processor 104 instructs the storage controller 101 to store the received transmission information (Step S711). Thus, the storage controller 101 stores the concerned transmission information in the large-capacity storage 13 (Step S712). When all sets of transmission information are received, the reception processor 104 notifies the determiner 106 about completion of reception (Step S713). Upon receiving the notification, the determiner 106 performs scheduling of the transmission timings for sending the transmission information (Step S714).

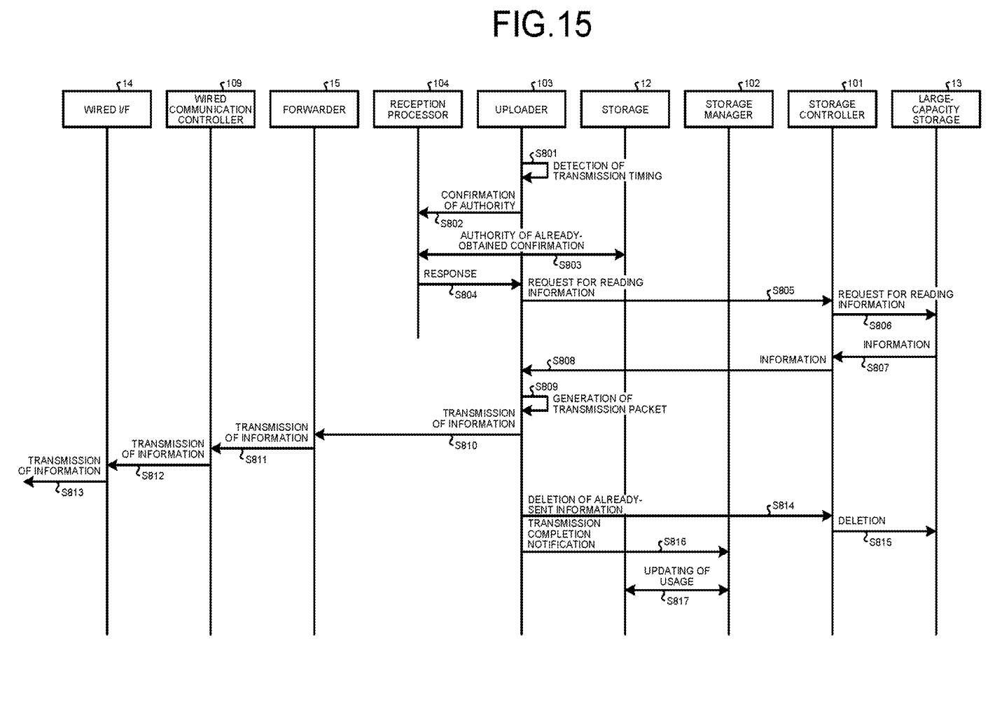

Given below is further explanation of the operation of uploading transmission information to the server 300. FIG. 15 is a sequence diagram for explaining the operation of uploading transmission information.

The uploader 103 detects the arrival of a transmission timing (Step S801). Then, the uploader 103 requests the authority manager 105 to confirm the authority (Step S802).

The authority manager 105 refers to the storage 12, for example; and confirms the already-obtained authority (Step S803). Then, the authority manager 105 sends the confirmation result to the uploader 103 (Step S804).

The uploader 103 requests the storage controller 101 to read the transmission information (Step S805). Thus, the storage controller 101 reads the transmission information from the large-capacity storage 13 (Step S806), and retrieves the transmission information (Step S807). Then, the storage controller 101 sends the transmission information to the uploader 103 (Step S808).

The uploader 103 generates a transmission packet for the purpose of sending the transmission information (Step S809). Then, the uploader 103 sends the transmission packet to the server 300 via the forwarder 15, the wired communication controller 109, and the wired I/F 14 (Steps S810 to S813).

The uploader 103 requests the storage controller 101 to delete the already-sent transmission information (Step S814). Thus, the storage controller 101 deletes the concerned transmission information from the large-capacity storage 13 (Step S815). The uploader 103 notifies the storage manager 102 about the completion in transmission of the transmission information (Step S816). Then, according to the size of the already-sent transmission information, the storage manager 102 updates the usage of the storage 12 (Step S817).

### First Modification Example

In the first embodiment, the AP 100 and the server 300 are connected using wired communication. Alternatively, it is possible to use wireless communication. In that case, it is possible to implement any arbitrary wireless communication method. For example, it is possible to implement a multi-hop connection using the wireless technology having a relatively narrow communication range; or it is possible to use a communication technology having a wide communication range (for example, 3-rd generation/4-th generation/5-th generation mobile communication, WiMAX, or microwaves).

In this way, in the communication system according to the first embodiment, when resources can be allocated, transmission information is sent from the in-vehicle device 200 to the AP 100, and then the transmission information is uploaded from the AP 100 to the server 300 at an arbitrary timing. Thus, communication between a terminal device, a communication device, and a server device can be performed in a more stable manner. That is, the communication time taken for communicating transmission information can be shortened, and the communicability in motion can be enhanced. Besides, because of the shortening of the communication time, low power consumption can also be achieved.

### Second Embodiment

In a communication system according to a second embodiment, the wireless communication used in preliminary setup communication is different than the wireless communication used in data communication.

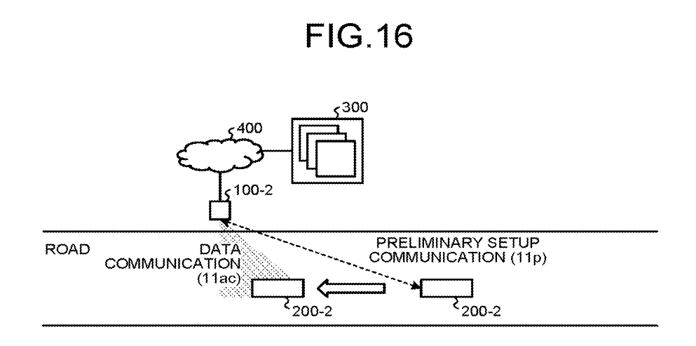

FIG. 16 is a diagram illustrating an exemplary overall configuration of the communication system according to the second embodiment. According to the second embodiment, the communication system illustrated in FIG. 16 includes an AP 100-2, an in-vehicle device 200-2, the server 300, and the network 400. In the following explanation, the configuration identical to the first embodiment is referred to with the same reference numerals, and the explanation is not repeated.

The AP 100-2 as well as the in-vehicle device 200-2 has the function of performing wireless communication at a relatively low speed (such as IEEE 802.11p) for the purpose of preliminary setup communication and has the function of performing wireless communication at a relatively high speed (such as IEEE 802.11ac) for the purpose of data communication.

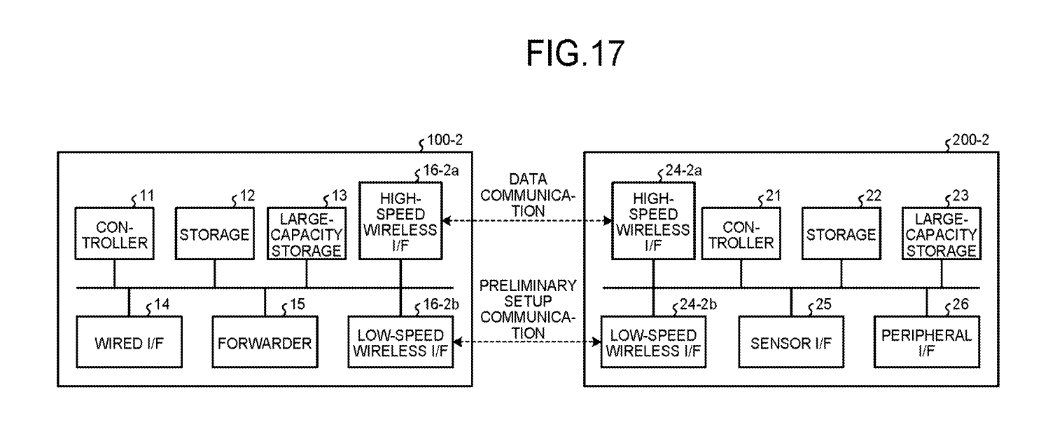

FIG. 17 is a diagram illustrating an exemplary hardware configuration of the AP 100-2 and the in-vehicle device 200-2. As illustrated in FIG. 17, the AP 100-2 includes the controller 11, the storage 12, the large-capacity storage 13, the wired I/F 14, the forwarder 15, a high-speed wireless I/F 16-2a, and a low-speed wireless I/F 16-2b. The in-vehicle device 200-2 includes the controller 21, the storage 22, the large-capacity storage 23, a high-speed wireless I/F 24-2a, a low-speed wireless I/F 24-2b, the sensor I/F 25, and the peripheral I/F 26. As far as the sensor I/F 25 and the peripheral I/F 26 are concerned, the implementation is identical to the first embodiment.

The high-speed wireless I/Fs 16-2a and 24-2a are, for example, interfaces based on the IEEE 802.11ac standard considered for high-speed data communication. The low-speed wireless I/Fs 16-2b and 24-2b are, for example, interfaces based on the IEEE 802.11p standard.

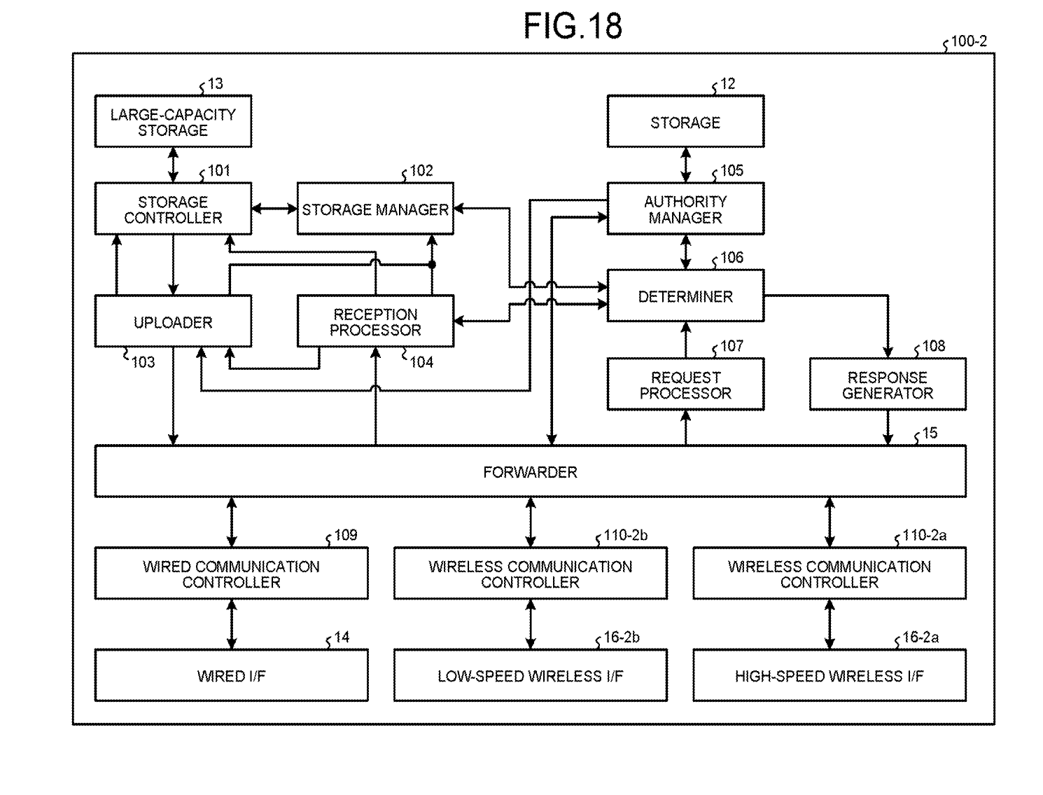

Given below is the explanation of an exemplary functional configuration of the AP 100-2. FIG. 18 is a block diagram illustrating an exemplary functional configuration of the AP 100-2. As illustrated in FIG. 18, the AP 100-2 includes the storage 12, the large-capacity storage 13, the wired I/F 14, the forwarder 15, the high-speed wireless I/F 16-2a, the low-speed wireless I/F 16-2b, the storage controller 101, the storage manager 102, the uploader 103, the reception processor 104, the authority manager 105, the determiner 106, the request processor 107, the response generator 108, the wired communication controller 109, and wireless communication controllers 110-2a and 110-2b.

As compared to the first embodiment, the second embodiment differs in the way that the wireless communication controllers 110-2a and 110-2b correspond to the high-speed wireless I/F 16-2a and the low-speed wireless I/F 16-2b, respectively.

The wireless communication controller 110-2a controls the communication performed via the high-speed wireless I/F 16-2a. The wireless communication controller 110-2b controls the communication performed via the low-speed wireless I/F 16-2b. Meanwhile, the configuration can alternatively be such that a single wireless communication controller has the functions of the wireless communication controllers 110-2a and 110-2b.

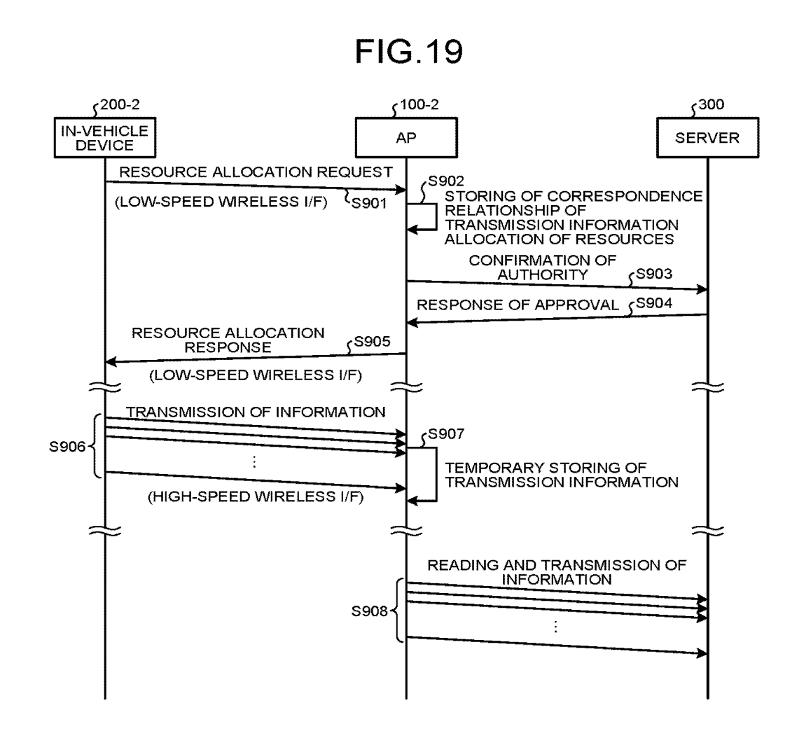

Explained below with reference to FIG. 19 is a communication operation performed by the AP 100-2 configured in the abovementioned manner according to the second embodiment. FIG. 19 is a sequence diagram for explaining an example of the communication operation according to the second embodiment.

The operations from Steps S901 to S908 are identical to the operations illustrated in the sequence diagram of the communication operation according to the first embodiment (Steps S101 to S108 illustrated in FIG. 5). However, the difference with the first embodiment is that a resource allocation request and transmission information are sent using different wireless I/Fs.

More particularly, at Steps S901 and S905, a resource allocation request and a resource allocation response are sent and received via the low-speed wireless I/Fs 16-2b and 24-2b. At Step S906, transmission information is sent and received via the high-speed wireless I/Fs 16-2a and 24-2a.

At Step S906, after the setup operation is performed, the AP 100-2 can wait for a trigger and start transmission when the trigger is received. Herein, a beacon or a particular data frame can serve as the trigger. If the electrical power of the trigger frame is reduced to low, then the trigger frame becomes detectible only in the vicinity of the AP 100-2. Thus, if the in-vehicle device 200-2 performs transmission at the usual electrical power, high-speed communication can be achieved. Meanwhile, as described earlier, when the possible timing for transmission during the preliminary setup communication is notified from the AP 100, transmission can be held back till that timing.

With such a configuration, the preliminary setup can be done even when the in-vehicle device 200-2 and the AP 100-2 are separated by a distance. Moreover, since preliminary setup communication and data communication are performed separately, the setup operation can be performed without fail. Besides, because of such separation in the communication, stability in the data transfer can be achieved along with enhancement in the throughput.

### Third Embodiment

In a communication system according to a third embodiment, the preliminary setup communication is performed using a cellular network.

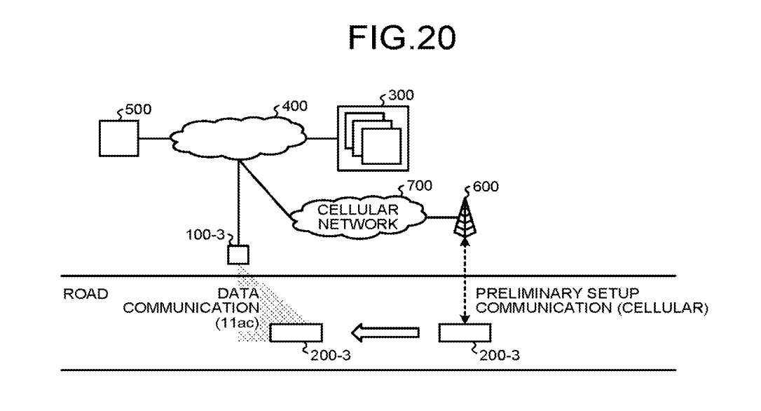

FIG. 20 is a diagram illustrating an exemplary overall configuration of the communication system according to the third embodiment. As illustrated in FIG. 20, the communication system according to the third embodiment includes an AP 100-3, an in-vehicle device 200-3, the server 300, the network 400, a server 500, a base station 600, and a cellular network 700.

The cellular network 700 represents a network for performing cellular communication used in cellular phones. The base station 600 is a wireless station used in the cellular network 700.

The server 500 determines the transfer destination for a preliminary setup request that is received from the cellular network 700. For example, the server 500 determines the AP 100-3, which is close to the in-vehicle device 200 that issued the request, as the transfer destination. The server 500 can obtain position information from the in-vehicle device 200-3 or the base station 600, and determine the closest AP 100-3 by referring to the position information. However, the method by which the server 500 determines the transfer destination is not limited to the method of using position information. Alternatively, it is possible to implement an identical method to the method for determining the transfer destination as explained in a latter embodiment. Meanwhile, the functions of the server 500 and the server 300 can alternatively be implemented in a single server.

The AP 100-3 that is determined as the transfer destination performs a setup operation such as securing the resources. Then, the AP 100-3 sends a response with respect to the setup request to the in-vehicle device 200-3 via the server 500 and the cellular network 700.

The in-vehicle device 200-3 has the function of performing communication via the cellular network 700 for the purpose of preliminary setup communication. The AP 100-3 receives a preliminary setup request via, for example, the network 400, the server 500, and the cellular network 700. Moreover, the AP 100-3 as well as the in-vehicle device 200-3 has the function of performing wireless communication at a relatively high speed (such as IEEE 802.11ac) for the purpose of data communication.

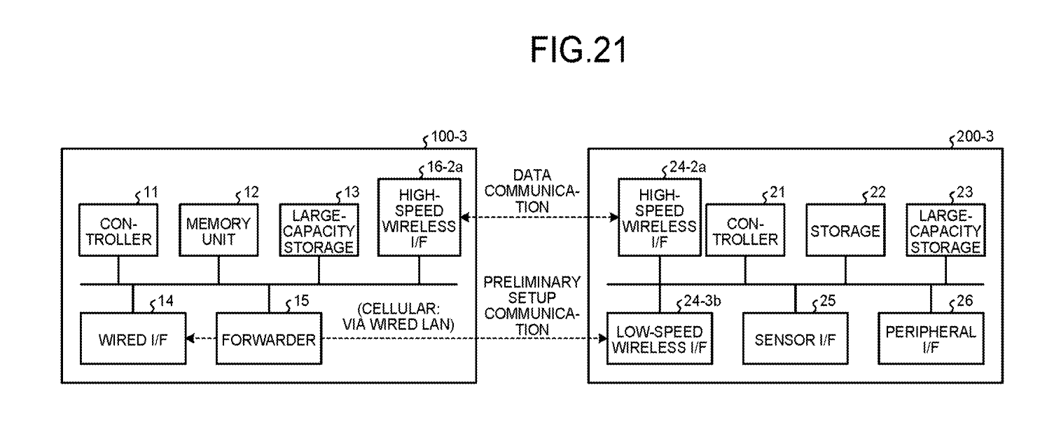

FIG. 21 is a diagram illustrating an exemplary hardware configuration of the AP 100-3 and the in-vehicle device 200-3. As illustrated in FIG. 21, the AP 100-3 includes the controller 11, the storage 12, the large-capacity storage 13, the wired I/F 14, the forwarder 15, and the high-speed wireless I/F 16-2a. The in-device vehicle 200-3 includes the controller 21, the storage 22, the large-capacity storage 23, the high-speed wireless I/F 24-2a, a low-speed wireless I/F 24-3b, the sensor I/F, and the peripheral I/F 26.

The low-speed wireless I/F 24-3b is an interface for performing wireless communication of the cellular type.

Meanwhile, the AP 100-3 according to the third embodiment is equivalent to the configuration in which the low-speed wireless I/F 16-2b is removed from the AP 100-2 according to the second embodiment. Hence, the detailed explanation of the functional configuration of the AP 100-3 is not repeated. For example, the functional configuration of the AP 100-3 can be obtained by removing the wireless communication controller 110-2b and the low-speed wireless I/F 16-2b from the configuration illustrated in FIG. 18.

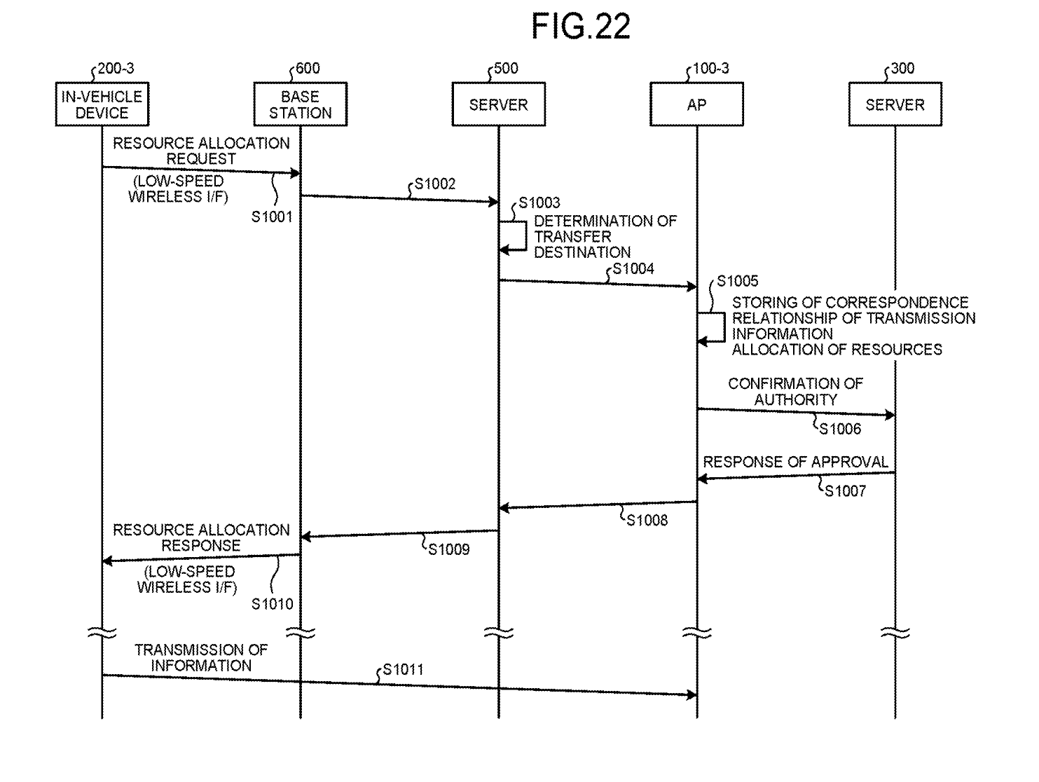

Explained below with reference to FIG. 22 is a communication operation performed by the AP 100-3 configured in the abovementioned manner according to the third embodiment. FIG. 22 is a sequence diagram for explaining an example of the communication operation according to the third embodiment.

The in-vehicle device 200-3 sends a resource allocation request to the server 500 via the base station 600 (Steps S1001 and S1002). The server 500 determines the AP 100-3 to which the resource allocation request is to be transferred (Step S1003). Then, the server 500 sends the resource allocation request to the AP 100-3 (Step S1004). Herein, the AP 100-3 receives the resource allocation request via the wired I/F 14.

The operations performed from Steps S1005 to S1007 are identical to the operations performed from Steps S102 to S104 illustrated in FIG. 5. Meanwhile, in the case in which communication needs to be performed with the in-vehicle device 200-3 for the purpose of authority confirmation, information is sent and received via the server 500 and the cellular network 700 (the base station 600).

The AP 100-3 sends a resource allocation response to the in-vehicle device 200-3 via the wired I/F 14, the server 500, and the base station 600 (Steps S1008 to S1010). Then, the in-vehicle device 200 starts sending the transmission information (Step S1011). The subsequent operations are identical to the operations performed at Steps S107 and S108 illustrated in FIG. 5. Hence, the explanation is not repeated.

With such a configuration, it becomes possible to achieve an identical effect to the effect achieved in the second embodiment, for example.

### Fourth Embodiment

In a fourth embodiment, the explanation is given for an example in which preliminary data communication and data communication is dispersedly performed using a plurality of communication devices (APs).

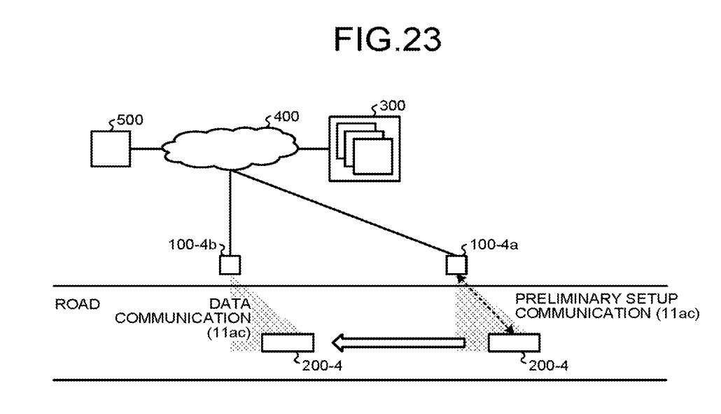

FIG. 23 is a diagram illustrating an exemplary overall configuration of a communication system according to the fourth embodiment. As illustrated in FIG. 23, the communication system according to the fourth embodiment includes APs 100-4a and 100-4b, an in-vehicle device 200-4, the server 300, the network 400, and the server 500.

The APs 100-4a and 100-4b have an identical configuration. Hence, when it is not necessary to distinguish between the APs 100-4a and 100-4b, they are simply referred to as an AP 100-4. Meanwhile, as described later, in a case in which the AP 100-4 determines the transfer destination, the server 500 may be omitted.

The AP 100-4 also has a function by which, when a resource allocation request is received, the AP 100-4 determines whether to respond to the request on its own or to make an external device (another AP 100-4) respond to the request and, in the case of making using another AP 100-4 respond, determines the transfer destination of the resource allocation request. Meanwhile, alternatively, the server 500 can be made to determine the transfer destination.

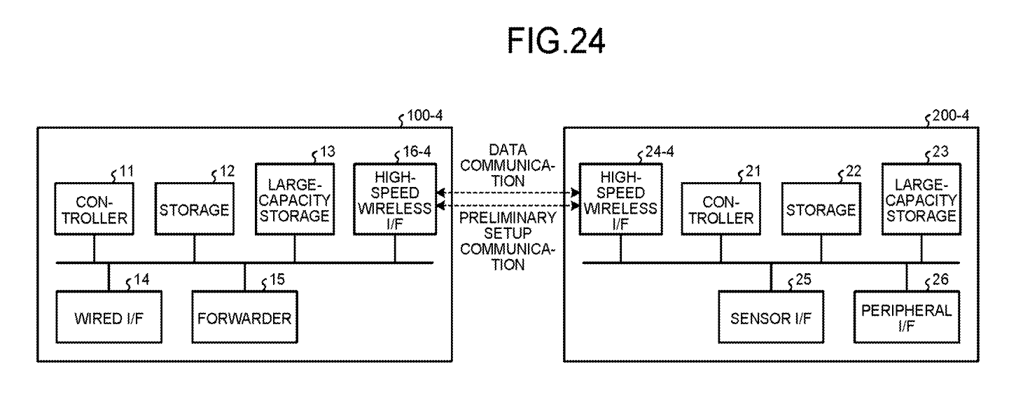

FIG. 24 is a diagram illustrating an exemplary hardware configuration of the AP 100-4 and the in-vehicle device 200-4. As illustrated in FIG. 24, the AP 100-4 includes the controller 11, the storage 12, the large-capacity storage 13, the wired I/F 14, the forwarder 15, and a high-speed wireless I/F 16-4. The in-vehicle device 200-4 includes the controller 21, the storage 22, the large-capacity storage 23, a high-speed wireless I/F 24-4, the sensor I/F 25, and the peripheral I/F 26.

The high-speed wireless I/Fs 16-4 and 24-4 are, for example, interfaces based on the IEEE 802.11ac standard considered for high-speed data communication. Herein, the high-speed wireless I/Fs 16-4 and 24-4 are used in preliminary setup communication as well as data communication.

### Second Modification Example

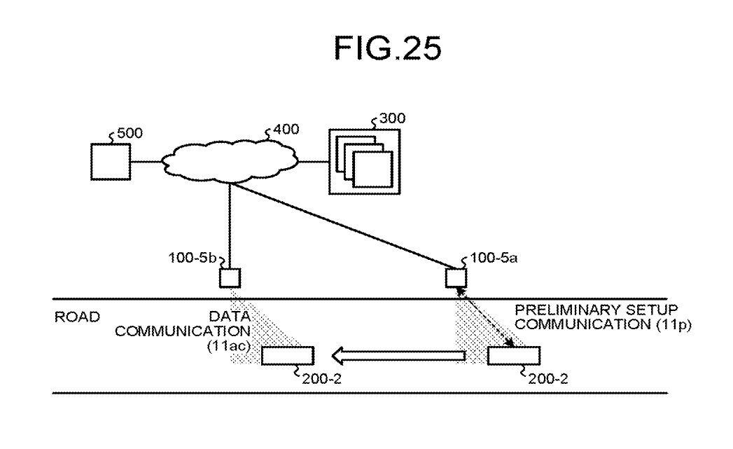

Alternatively, the configuration can be such that preliminary setup communication and data communication can be performed using different interfaces. FIG. 25 is a diagram illustrating an overall configuration of a communication system configured in the abovementioned manner according to a modification example of the fourth embodiment. As illustrated in FIG. 25, the communication according to a second modification example includes APs 100-5a and 100-5b, the in-vehicle device 200-2, the server 300, the network 400, and the server 500.

The APs 100-5a and 100-5b have an identical configuration. Hence, when it is not necessary to distinguish between them, they are simply referred to as an AP 100-5. Herein, for example, the AP 100-5 implements IEEE 802.11ac for data communication and implements IEEE 802.11p for preliminary setup communication.

The AP 100-5 according to the second modification example has an identical hardware configuration to the hardware configuration of the AP 100-2 (FIG. 17) according to the second embodiment, for example.

Given below is the explanation of an exemplary functional configuration of the AP 100-4. Since the AP 100-5 has an identical functional configuration to the functional configuration of the AP 100-4, the following explanation is given only about the AP 100-4.

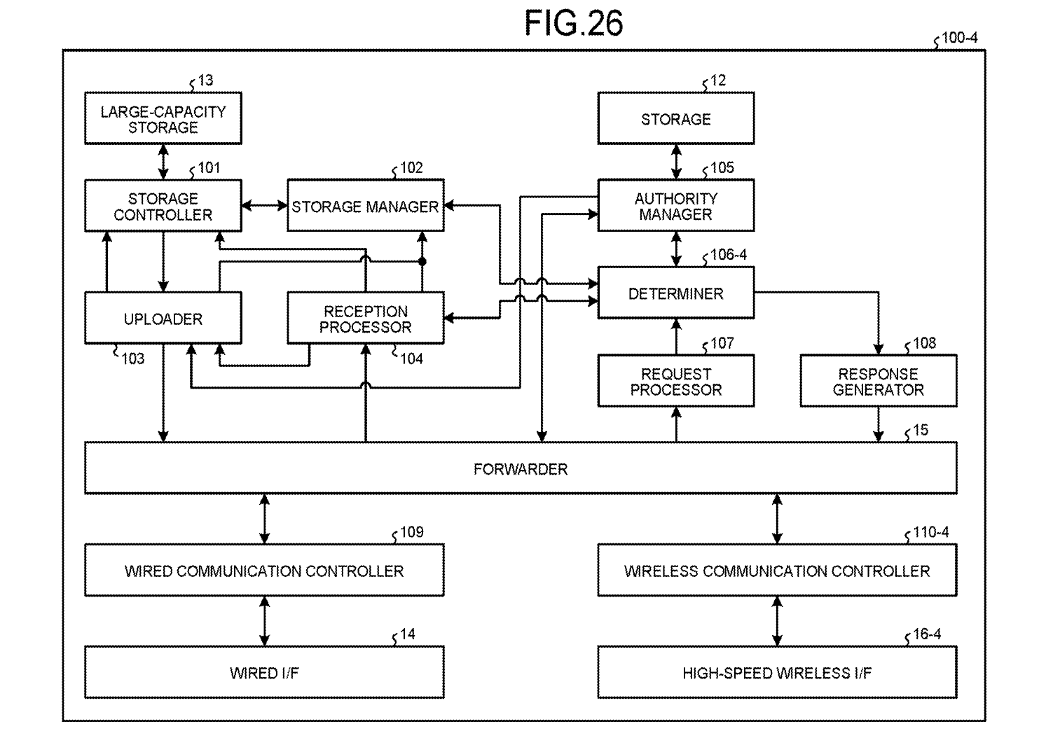

FIG. 26 is a block diagram illustrating an exemplary functional configuration of the AP 100-4. As illustrated in FIG. 26, the AP 100-4 includes the storage 12, the large-capacity storage 13, the wired I/F 14, the forwarder 15, the high-speed wireless I/F 16-4, the storage controller 101, the storage manager 102, the uploader 103, the reception processor 104, the authority manager 105, a determiner 106-4, the request processor 107, the response generator 108, the wired communication controller 109, and a wireless communication controller 110-4.

In the fourth embodiment, the wireless I/F 16, the determiner 106, and the wireless communication controller 110 are replaced with the high-speed wireless I/F 16-4, the determiner 106-4, and the wireless communication controller 110-4, respectively, of the AP 100 (FIG. 4) according to the first embodiment.

The wireless communication controller 110-4 controls the communication performed via the high-speed wireless I/F 16-4.

As compared to the determiner 106 according to the embodiments described earlier, the determiner 106-4 differs in the way of further having a function that, when a resource allocation request is received, enables the corresponding AP 100-4 to determine whether to respond to the request on its own or to make another AP 100-4 respond to the request and having a function for determining the transfer destination of the resource allocation request.

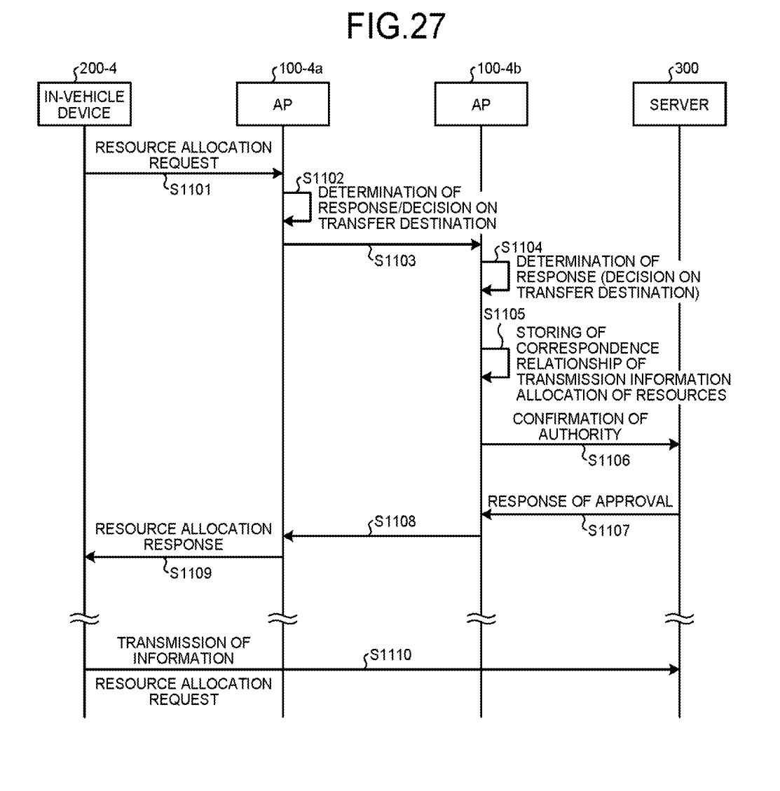

Explained below with reference to FIG. 27 is a communication operation performed by the AP 100-4 configured in the abovementioned manner according to the fourth embodiment. FIG. 27 is a sequence diagram for explaining an example of the communication operation according to the fourth embodiment.

The in-vehicle device 200-4 sends a resource allocation request to the AP 100-4a (Step S1101). Thus, the AP 100-4a receives the resource allocation request via the high-speed wireless I/F 16-4. Herein, the AP 100-4 determines whether to process the resource allocation request on its own and, in the case of not processing the resource allocation request on its own, determines the transfer destination of the resource allocation request (Step S1102).

The determiner 106-4 can determine the transfer destination by referring to the information stored in the storage (the storage 12 and the large-capacity storage 13). Herein, for example, correspondence relationship between transmission information and transmission statuses, such as “being transferred”, can be stored in the storage 12.

Assume that the AP 100-4b is determined as the transfer destination. Thus, the AP 100-4a sends the resource allocation request to the AP 100-4b via the wired I/F 14 (Step S1103).

The AP 100-4b receives the resource allocation request transferred via the wired I/F 14, and performs determination in an identical manner to Step S702 (Step S1104). Herein, it is assumed that the AP 100-4b determines to process the resource allocation request on its own.

The operations performed from Steps S1105 to S1107 are identical the operations performed from Steps S102 to S106 illustrated in FIG. 5. Meanwhile, in the case in which communication with the in-vehicle device 200-4 needs to be performed for the purpose of authority confirmation, information is sent and received via the APs 100-4b and 100-4a.

The AP 100-4b sends a resource allocation response to the in-vehicle device 200-4 via the wired I/F 14 and the AP 100-4a (Steps S1108 and S1109). Then, the in-vehicle device 200-4 starts sending the transmission information (Step S1110). The subsequent operations are identical to the operations performed at Steps S107 and S108 illustrated in FIG. 5. Hence, the explanation is not repeated.

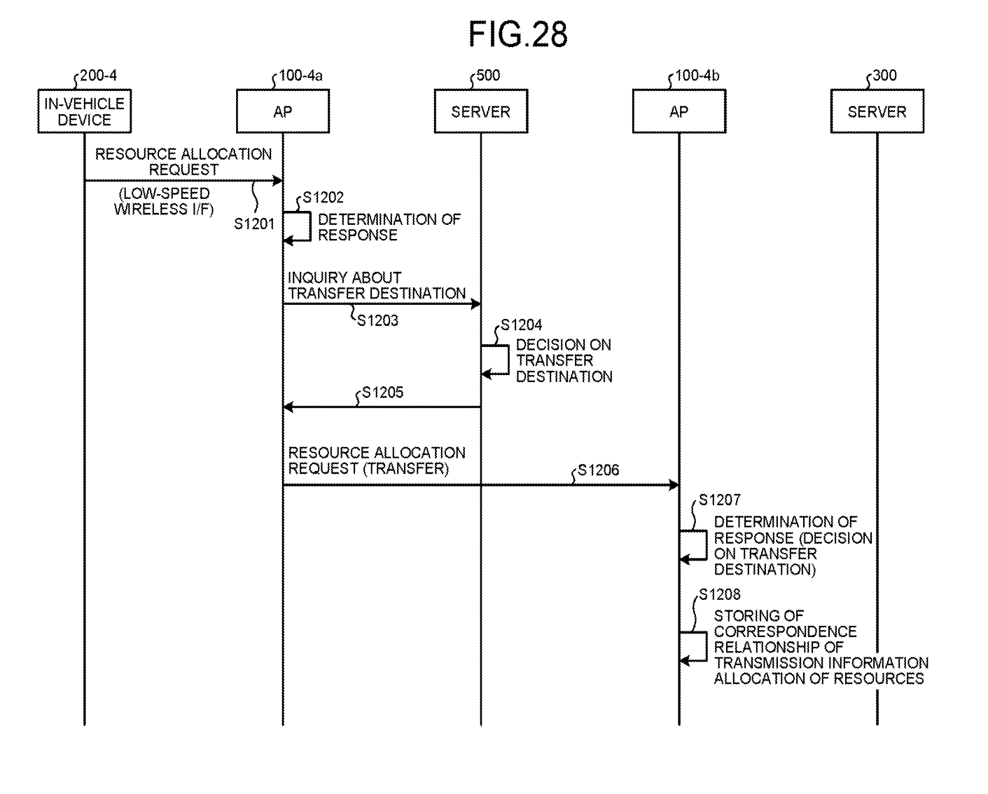

Given below is the explanation of a flow of operations performed in a case in which the server 500 determines the AP 100-4 that would serve as the transfer destination. FIG. 28 is a sequence diagram for explaining an example of the communication operation in that case.

The in-vehicle device 200-4 sends the resource allocation request to the AP 100-4a (Step S1201). The AP 100-4a determines whether to process the resource allocation request on its own (Step S1202) and, in the case of not processing the resource allocation request on its own, inquires the server 500 about the transfer destination (Step S1203).

Upon receiving the inquiry, the server 500 determines the transfer destination (Step S1204) and notifies it to the AP 100-4a (Step S1205). Herein, assume that the AP 100-4b is determined as the transfer destination. Thus, the AP 100-4a sends the resource allocation request to the AP 100-4b (Step S1206).

The operations performed at Steps S1207 and S1208 are identical to the operations performed at Steps S1104 and S1105 illustrated in FIG. 27. Moreover, the subsequent operations are identical to the operations performed from Step S1106 onward as illustrated in FIG. 26. Hence, the explanation is not repeated.

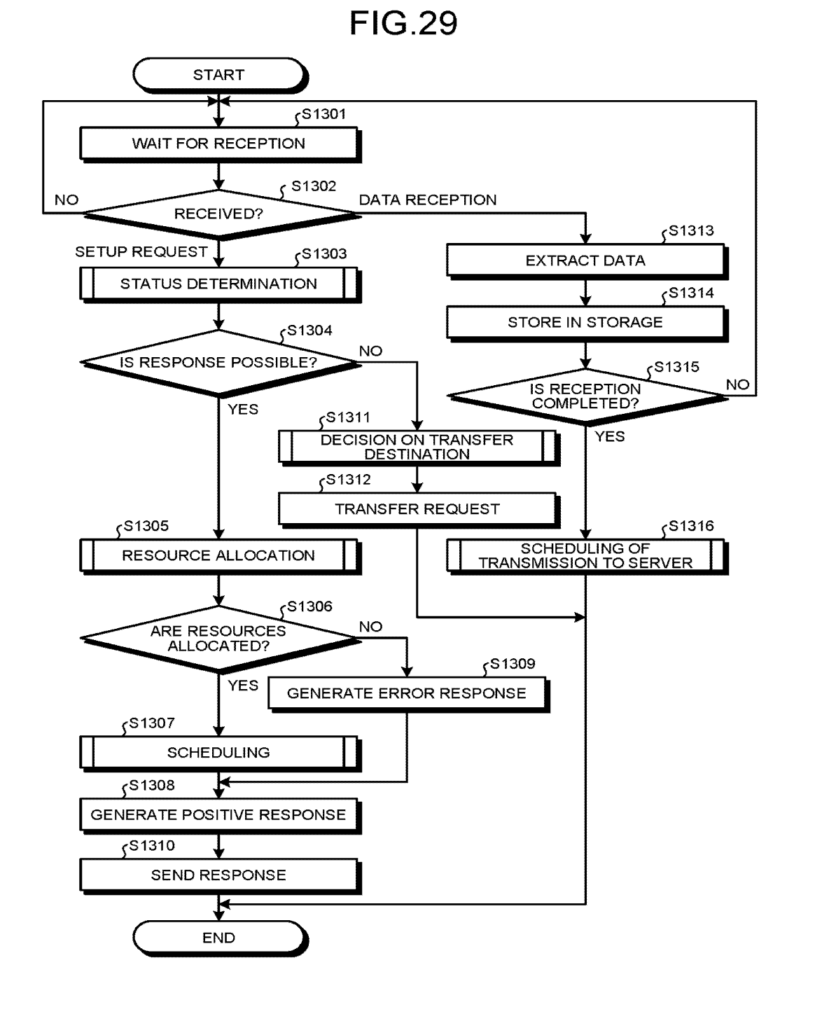

Explained below with reference to FIG. 29 are the details of the communication operation according to the fourth embodiment. FIG. 29 is a flowchart for explaining an example of the communication operation according to the fourth embodiment. Herein, FIG. 29 represents an example in the case in which the transfer destination is determined by the concerned AP.

The operations performed at Steps S1301 and S1302 are identical to the operations performed at Steps S201 and S202, while the operations performed from Steps S1313 to S1316 are identical to the operations performed from Steps S210 to S213.

When the preliminary setup request is received (setup request at Step S1302), the determiner 106-4 performs a status determination operation for determining whether to respond to the preliminary setup request using the corresponding AP 100-4 (Step S1303). The details of the status determination operation are given later.

The determiner 106-4 determines whether or not the corresponding AP 100-4 can respond to the preliminary setup request (Step S1304). If the corresponding AP 100-4 can respond to the preliminary setup request (Yes at Step S1304), then the determiner 106-4 performs a resource allocation operation (Step S1305). The operations from Step S1305 onward (i.e., from Steps S1305 to S1310) are identical to the operations performed from Steps S204 to S209. Hence, the explanation is not repeated.

However, if the concerned AP 100-4 cannot respond to the preliminary setup request (No at Step S1304), then the determiner 106-4 performs a determination operation for determining the transfer destination (Step S1311). The details of the determination operation are given later. After performing the determination operation, the determiner 106-4 makes use of the request processor 107 and transfers the resource allocation request to the determined transfer destination (Step S1312).

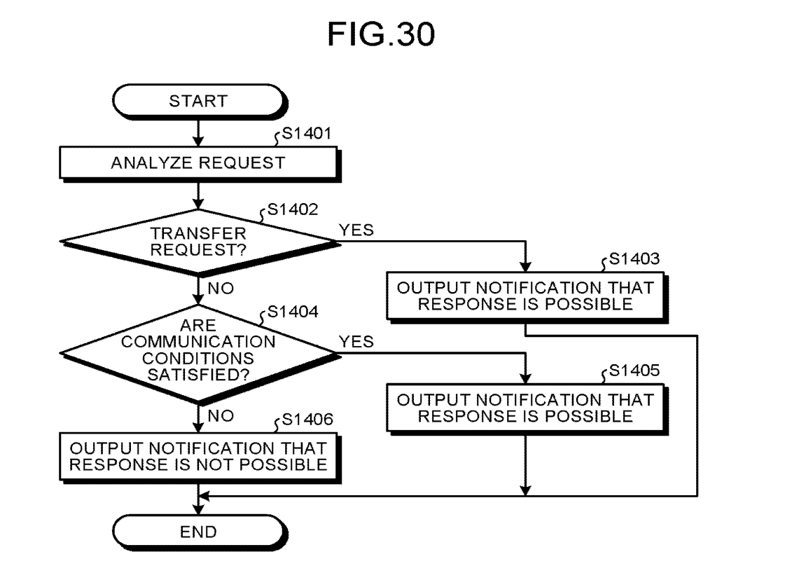

Given below is the explanation of the status determination operation performed at Step S1303. FIG. 30 is a flowchart for explaining an example of the status determination operation.

The determiner 106-4 analyzes the received request (Step S1401). That is, the determiner 106-4 determines whether or not the request is a resource allocation request that has been transferred (Step S1402). If the request is a resource allocation request (Yes at Step S1402), then the determiner 106-4 outputs the fact indicating that a response to the resource allocation request can be given (Step S1043). That marks the end of the operations. Meanwhile, whether or not the request is a transferred request can be determined by implementing one of the following methods: a method in which it is determined whether or not a field indicating the presence or absence of transfer is set in the request message; a method in which determination is performed according to the difference in the communication protocol used in communication, or according to the difference in the IP address used in communication, or according to the difference in the port number used in communication; and a method in which determination is performed according to the difference in the interface used in receiving the resource allocation request.

If the request is not a resource allocation request (No at Step S1402), then the determiner 106-4 determines whether or not required communication conditions are satisfied (Step S1404).

Herein, the determiner 106-4 determines the following communication conditions, for example. It is possible to use either all or some of the conditions given below.

(First Condition) Whether the Terminal Device is in a Suitable State for Communication

For example, it is determined whether information indicating the quality of the communication channel and information enabling estimation of the operating condition of the in-vehicle device 200-4 satisfies a predetermined standard. Examples of the information indicating the quality of the communication channel include the packet error rate (PER), the received signal strength indication (RSSI), the signal to noise ratio (SNR), and the link speed. Examples of the information enabling estimation of the operating condition of the in-vehicle device 200-4 include the fluctuation in the wavelength attributed to the Doppler effect. For example, when such information is present on the side of being suitable for communication than a predetermined threshold value, the determiner 106-4 determines that the communication condition is satisfied. Otherwise, the determiner 106-4 determines that the communication condition is not satisfied. For example, the operating condition of the in-vehicle device 200-4 can be determined and, if the vehicle speed is sufficiently slow and if immediate communication is possible, then it can be determined that the communication condition is satisfied.

(Second Condition) Whether the Terminal Device Confirms to Operation Rules

For example, the determiner 106-4 determines whether the in-vehicle device 200-4 that requested communication setup confirms to operation rules; or determines whether the manufacturer, the vehicle type, the vehicle identification number, the fleet number, the manufacturing number, the other components, and the software version of the vehicle in which the in-vehicle device 200 is installed confirms to operation rules. If such information confirms to operation rules, then the determiner 106-4 determines that the communication condition is satisfied. Otherwise, the determiner 106-4 determines that the communication condition is not satisfied. The operation rules are stored in advance in the AP 100-4, for example.

When such communication conditions are satisfied (Yes at Step S1404), the determiner 106-4 outputs a notification that a response to the resource allocation request can be given (Step S1405). That marks the end of the operations. However, if the communication conditions are not satisfied (No at Step S1404), then the determiner 106-4 outputs a notification that a response to the resource allocation request cannot be given (Step S1406). That marks the end of the operations.

Meanwhile, whether or not to accept the resource allocation request can be determined by further taking into account the following condition.

For example, if the resource allocation request is accepted as it is, then it may lead to a bias in the information transmission frequency. As an example of the reason for such bias, in a convoy, it easier for the leading vehicle to stop near a signal. Such a situation may occur regardless of whether the preliminary setup has been performed via a third party (the server 500) or whether the communication method of the preliminary setup communication is same as the communication method of the data communication.

In that regard, depending on the transmission information, the sender, the vehicle features, and the transmission frequency; acceptance of the resource allocation request may be refused. As described above, the characteristics of the transmission information include the size, the priority (the degree of importance), and the format. The priority includes the priority that can be arbitrarily set and the priority that can be forcibly set (in the case of information from an emergency vehicle). Regarding the in-vehicle device 200-4 that is not installed in an emergency vehicle but that sends useful data, it is possible to set incentives according to the features and the attributes of the sender/vehicle. For example, if a vehicle can send information (such as the intermediate result of image recognition of the road condition captured using an in-vehicle camera) suitable for decentralized cooperation, then that vehicle can be given a higher priority. Meanwhile, the configuration can be such that the information of a highly-public vehicle such as a bus (public information (road congestion information, rainfall information, snowfall information) that does not have much issue with privacy and that is easy to measure) is made to be easy-to-send, or the in-vehicle device 200-4 of a driver who is not a good driver is enabled to send information easily with the aim of preventing accidents beforehand.

In the case of performing determination according to the transmission frequency, the in-vehicle device 200-4 sends transmission frequency information to the AP 100-4, for example. Then, based on the transmission frequency information, the determiner 106-4 of the AP 100-4 determines whether or not to accept the request. The transmission frequency information can be managed in a centralized manner in the server 500. For example, the server 500 can manage the transmission frequency and the data volume for each in-vehicle device 200-4 by referring to identification information that enables identification of the in-vehicle devices 200-4. Then, whether or not to accept a request can be determined based on the registered information.

Such determination about whether or not to accept a request is not limited to the fourth embodiment, and can be implemented to any other embodiment. For example, in addition to performing resource allocation determination, whether or not to accept a request can also be determined and an error response can be sent in the case of refusing the request.

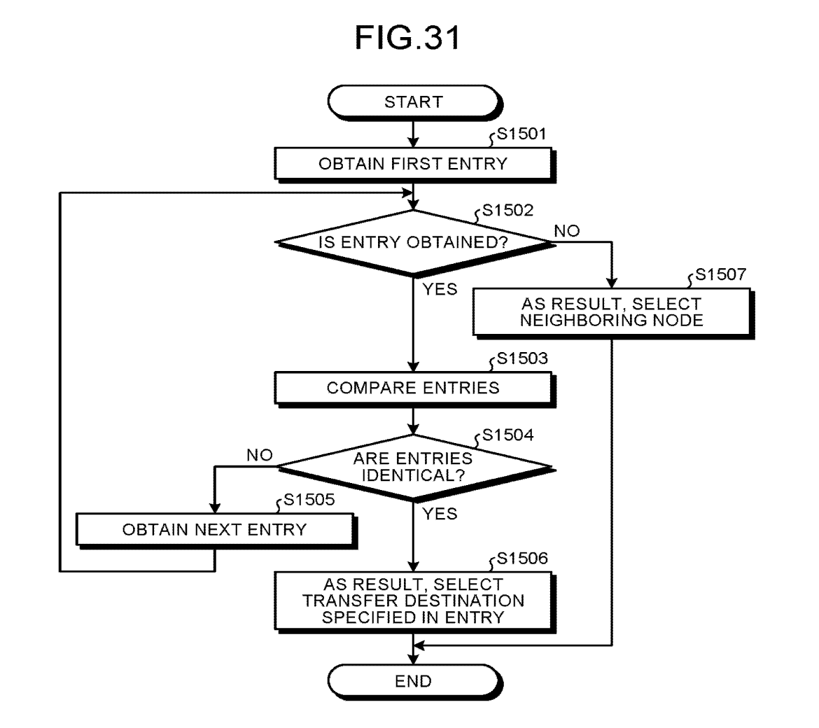

Given below is the explanation of the determination operation performed at Step S1311. FIG. 31 is a flowchart for explaining an example of the determination operation.

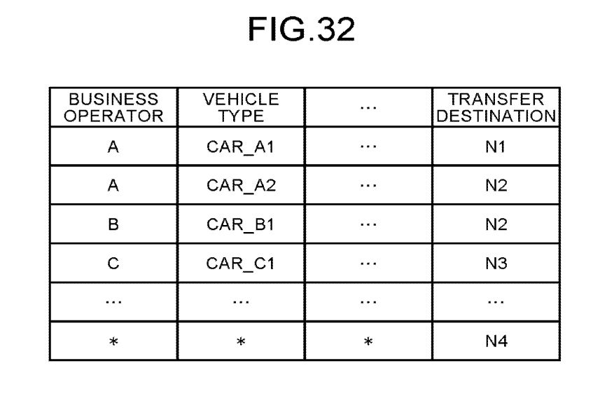

The determiner 106-4 obtains the first entry of transfer destination information that is stored in advance in the storage 12 (Step S1501). FIG. 32 is a diagram illustrating an example of the transfer destination information.

As illustrated in FIG. 32, the transfer destination information includes a plurality of entries in each of which information enabling identification of the manufacturer, information enabling identification of the vehicle type, and information enabling identification of the transfer destination is held in a corresponding manner. The information enabling identification of the transfer destination either can be information indicating the specific node (the AP 100-4) that would serve as the transfer destination or can be information indicating the number of hops for transfer (“one hop ahead” or “two hops ahead”). In the case of indicating the number of hops, the AP 100-4 that received the preliminary setup request can be treated as the start point, and the AP 100-4 that would serve as the transfer destination can be determined relative to the start point.

Returning to the explanation with reference to FIG. 31, the determiner 106-4 determines whether or not an entry was obtained (Step S1502). When an entry was obtained (Yes at Step S1502), the determiner 106-4 compares the information of the in-vehicle device 200 that sent the resource allocation request and the information included in the entry (Step S1503). For example, the information of the in-vehicle device 200 that sent the resource allocation request can be included in the resource allocation request. As may be necessary, the information on the AP 100-4 can also be included in the resource allocation request.

The determiner 106-4 determines whether or not the compared sets of information are identical (Step S1504). If the compared sets of information are not identical (No at Step S1504), then the operations are repeated. When the compared sets of information are identical (Yes at Step S1504), the determiner 106-4 selects the transfer destination specified in the entry (Step S1506). That marks the end of the operations.

Meanwhile, if the entry could not be obtained (No at Step S1502), the determiner 106-4 selects the neighboring AP 100-4 (the neighboring node) as the transfer destination (Step S1507). That marks the end of the operations. Meanwhile, in this sequence diagram, the matching entry is identified by means of iteration. Alternatively, a hash value can be calculated with respect to either some part of the resource allocation request or the entire resource allocation request, and the transfer destination can be determined based on the hash value.

In this way, in the fourth embodiment, in case the matching entry to the transfer destination information is not eventually found, the neighboring node is selected as the transfer destination. Meanwhile, when a plurality of neighboring nodes is present, the setup request can be transferred to each neighboring node or can be transferred to a particular single node after further selecting that node. The single node can be selected either by means of random selection or by means of selection in descending order (or ascending order) of traffic volume.

As described above, the method for determining the transfer destination can be implemented when the server 500 attempts to determine the transfer destination. The server 500 can store therein the transfer destination information identical to that illustrated in FIG. 32 and can use it in determining the transfer destination. If the transfer destination information is managed in the server 500, it not only becomes possible to manage the APs 100-4 over a wider range (to manage a greater number of APs 100-4) but also becomes possible to use the information of the transferred request. Moreover, in addition to managing the items specified in FIG. 32, if the server 500 also manages the available resource quantity of the AP 100-4, then transfer destination determination can be done using the available resource quantity.

However, the method for determining the transfer destination is not limited to the method described above.

Given below is the explanation of another determination method.

For example, the determiner 106-4 can select, as candidates, one or more other APs 100-4 that are disposed anteriorly. In that case, the target APs 100-4 can be determined either in a fixed manner or in a dynamic manner. For example, the candidates can be selected using information such as the vehicle speed of the vehicles in which the in-vehicle devices 200-4 are installed; the number of communication requests held in each AP 100-4; attribute information (such as registration information, manufacturer, vehicle type, and manufacturing number) of the in-vehicle devices 200-4 or the vehicles; and the characteristics (such as the data size, the format, and the data type) of the requested transmission data. With that, determination of the AP 100-4 that would serve as the transfer destination can be done according to the last digit of the registration number (for example, according to the even number/odd number), and the manufacturer having a large share can frequently assign the AP 100-4 and disperse the information transmission timing.

When a plurality of APs 100-4 is selected (when a plurality of default destinations is present or a plurality of entries matching the same condition is present), the determiner 106-4 either can transfer the request to all candidates or can transfer the request to a limited to number of candidates. At that time, the number of candidates can be determined in a dynamic manner. Alternatively, for example, the number of candidates is set in advance. In the case of dynamically determining the number of candidates, the determiner 106-4 can refer to the vehicle speeds, the number of unprocessed communication requests, and the traffic volume; and then determine the number of candidates.

The transfer of the preliminary setup request can be done by multicasting or broadcasting, or can be done by wireless-level broadcasting. In that case, the corresponding AP 100-4 can be controlled according to the strength of radio waves.

The travelling direction of a vehicle can be known using the Doppler effect of the received waves or using information notified from the vehicle (such as the direction, global positioning system (GPS) information, or speedometer information). Moreover, if the communication range is fixed in advance, the communications partner can be limited to the traffic lane in a particular direction.

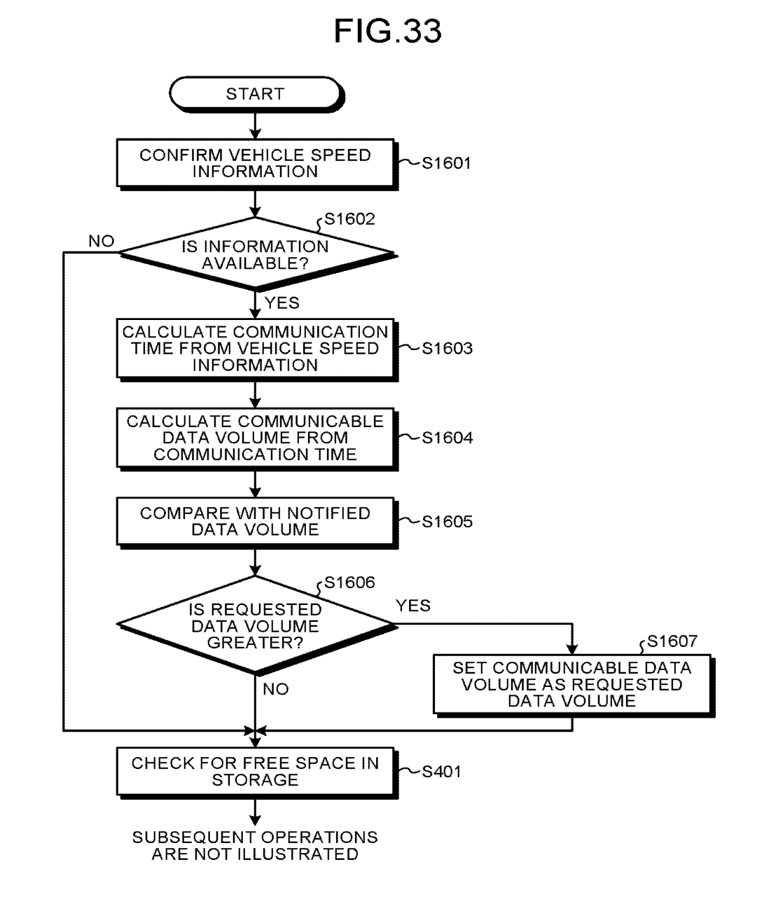

Meanwhile, whether or not the resources can be allocated can be determined using information such as the vehicle speed. FIG. 33 is a flowchart for explaining another example of the resource allocation operation. With reference to FIG. 33, the explanation is given about the operations performed before the resource allocation operation illustrated in FIG. 10A. In FIG. 33, the operations from Step S401 onward are identical to the operations illustrated in FIG. 10A.

The determiner 106 confirms whether vehicle speed information is obtained (Step S1601). The determiner 106 determines whether or not vehicle speed information is available (Step S1602). If vehicle speed information is not available (No at Step S1602), the system control proceeds to Step S410 for further operations.

When the vehicle speed information is available (Yes at Step S1602), the determiner 106 calculates the communication time from the vehicle speed information (Step S1603). Then, the determiner 106 calculates the communicable data volume from the calculated communication time (Step S1604). Subsequently, the determiner 106 compares the data volume of the transmission information to be sent and the communicable data volume that is calculated (Step S1605). The determiner 106 determines whether or not the data volume of transmission information to be sent (i.e., the requested data volume) is greater than the communicable data volume (Step S1606).

If the data volume of transmission information to be sent is not greater (No at Step S1606), the system control proceeds to Step S401 for further operations. However, if the data volume of transmission information to be sent is greater (Yes at Step S1606), then the determiner 106 sets the communicable data volume as the requested volume of transmission information (Step S1607). Meanwhile, when the requested volume is greater, the determiner 106 can return an error, or can reply with the maximum data volume that can be transmitted (i.e., reply with the communicable data volume).

The operation for confirming the vehicle speed or the communicable data can be performed in parallel to a storage-free-space confirmation operation that is performed subsequently.

The vehicle speed information can be calculated from the fluctuation in the wavelength attributed to the Doppler effect. In that case, the vehicle speed calculated by the AP 100 is not limited to the vehicle in which the target in-vehicle device 200 for communication is installed. For example, the vehicle speed of each of a plurality of vehicles passing by the AP 100 can be calculated, and the average of the calculated values can be obtained. Alternatively, the in-vehicle device 200 can measure the current speed of the vehicle according to some method, and can add the information about the measured speed (vehicle speed information) in the preliminary setup request message. Thus, the preliminary setup request message to be transferred to other APs 100 can also include the vehicle speed information.

The AP 100 serving as the transfer destination can calculate the communicable time period and the communicable data volume by referring to the vehicle speed information included in the preliminary setup request message. For example, the AP 100 refers to the vehicle speed and calculates the period of time required to pass through a high-speed communication area set in advance. Moreover, the AP 100 calculates the communicable data volume by multiplying the calculated period of time with the assumed throughput in the high-speed communication area.

Meanwhile, the resource allocation operation illustrated in FIG. 33 can be implemented as the resource allocation operation in the other embodiments too.

In this way, in the communication device according to the fourth embodiment, the preliminary setup can be performed in a dispersed manner using a plurality of APs 100-4. Hence, the preliminary setup can be performed with more certainty. Moreover, as a result of dividing the wireless space by means of dispersion and as a result of separating the preliminary setup from data communication, there is an enhancement in the stability of data transfer and the throughput. Furthermore, if IEEE 802.11p is used that is suitable for communication in motion (refer to the second modification example), it is possible to further enhance the stability of the preliminary setup and the data transfer.

### Fifth Embodiment

In the embodiments described till now, there is no clear specification about the manner in which an in-vehicle device prepares data and starts sending transmission information to an AP. In a fifth embodiment, the explanation is given for an example of operations performed when an in-vehicle device sends transmission information. The method explained in the fifth embodiment can also be implemented in the embodiments described above.

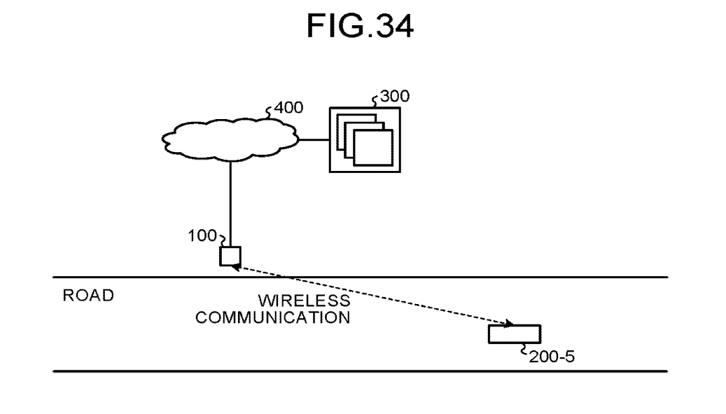

FIG. 34 is a diagram illustrating an exemplary overall configuration of a communication system according to the fifth embodiment. As illustrated in FIG. 34, the communication system according to the fifth embodiment includes the AP 100, an in-vehicle device 200-5, the server 300, and the network 400.

As illustrated in FIG. 34, the in-vehicle device 200-5 includes a wireless I/F for communicating with the AP 100. In the fifth embodiment, the in-vehicle device 200-5 also includes a wireless I/F for receiving transmission information from other devices (such as a cellular phone) present in the same vehicle.

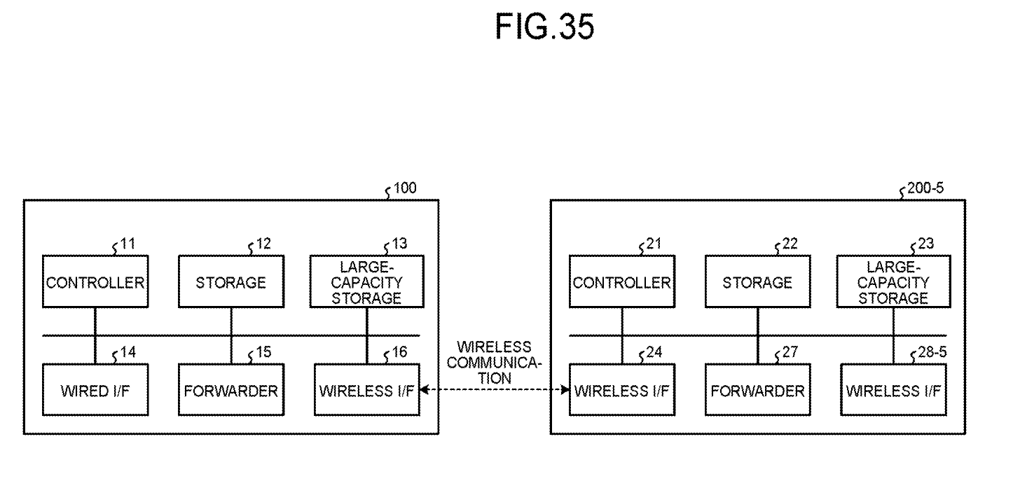

FIG. 35 is a diagram illustrating an exemplary hardware configuration of the in-vehicle device 200-5. As illustrated in FIG. 35, the in-vehicle device 200-5 includes the controller 21, the storage 22, the large-capacity storage 23, the wireless I/F 24, a forwarder 27, and a wireless I/F 28-5.

In the fifth embodiment, the forwarder 27 and the wireless I/F 28-5 are substituted for the sensor I/F 25 and the peripheral I/F 26 of the in-vehicle device 200 (FIG. 2) according to the first embodiment. However, the in-vehicle device 200-5 may include the sensor I/F 25 and the peripheral I/F 26 too.

The forwarder 27 has the identical function to the forwarder 15 of the AP 100. For example, the forwarder 27 performs a bridge operation between the wireless I/F 24 and the wireless I/F 28-5, and transfers frames. Moreover, from the frames received from outside, the forwarder 27 extracts frames to be processed using the functions of the controller 21 and transfers the frames to the respective functions. Furthermore, the forwarder 27 performs control so that the frames sent from the functions implemented by the controller 21 are sent via appropriate interfaces.

The wireless I/F 28-5 is an interface for performing wireless communication with the devices present in the vehicle. The wireless I/F 28-5 is based on, for example, IEEE 802.11a/b/g/n/ac. Meanwhile, the details about the functions of the in-vehicle device 200-5 are given later.

As illustrated in FIG. 35, the in-vehicle device 200-5 includes a storage (the large-capacity storage 23) and a wireless I/F to be used inside the vehicle (the wireless I/F 28-5). As a result, in an identical manner to the AP 100 according to the first embodiment, the in-vehicle device 200-5 can be operated in such a way that the data is temporarily stored in a storage and the stored data is sent at an arbitrary timing.

Meanwhile, regarding the configuration having the function of performing wireless communication with the devices present inside the vehicle, it is also possible to have the configurations explained below in third to fifth modification examples. Moreover, these configurations are only exemplary, and any other configuration can also be implemented.

### Third Modification Example

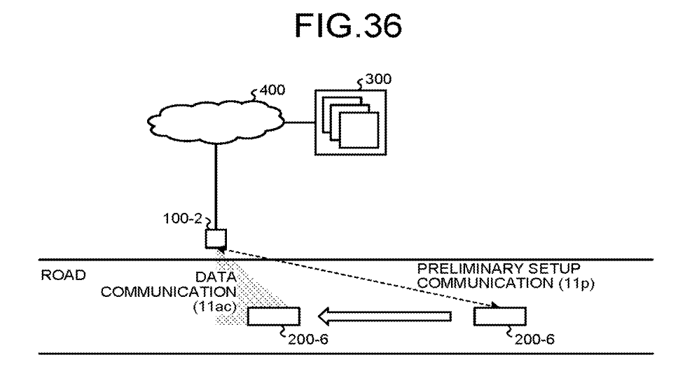

FIG. 36 is a diagram illustrating an exemplary overall configuration of a communication system according to a third modification example. As illustrated in FIG. 36, the communication system according to the third modification example includes the AP 100-2, an in-vehicle device 200-6, the server 300, and the network 400.

The in-vehicle device 200-6 has the function of performing wireless communication at a relatively low speed (such as IEEE 802.11p) for the purpose of preliminary setup communication and has the function of performing wireless communication at a relatively high speed (such as IEEE 802.11ac) for the purpose of data communication.

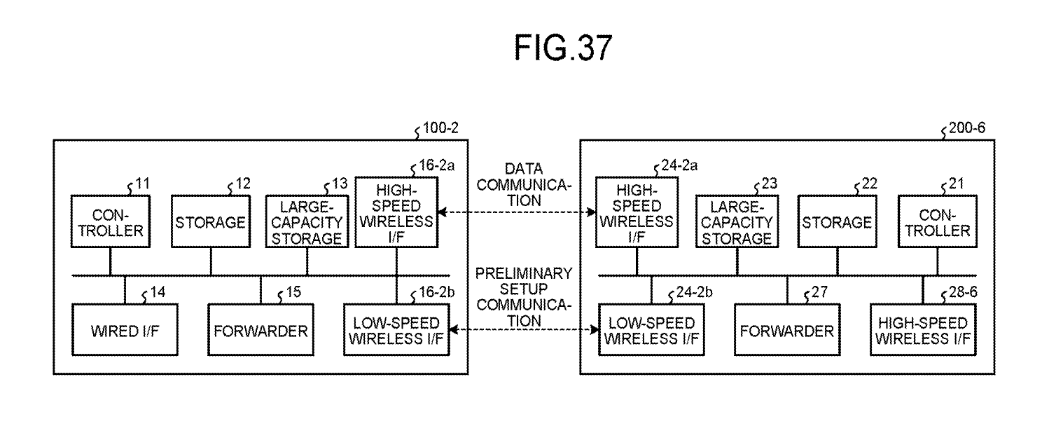

FIG. 37 is a diagram illustrating an exemplary hardware configuration of the in-vehicle device 200-6. As illustrated in FIG. 37, the in-vehicle device 200-6 includes the controller 21, the storage 22, the large-capacity storage 23, the high-speed wireless I/F 24-2a, the low-speed wireless I/F 24-2b, the forwarder 27, and a high-speed wireless I/F 28-6.

The high-speed wireless I/F 28-6 is an interface for performing wireless communication with the devices present inside the vehicle. For example, the high-speed wireless I/F 28-6 is based on the IEEE 802.11ac standard considered for high-speed data communication.

### Fourth Modification Example

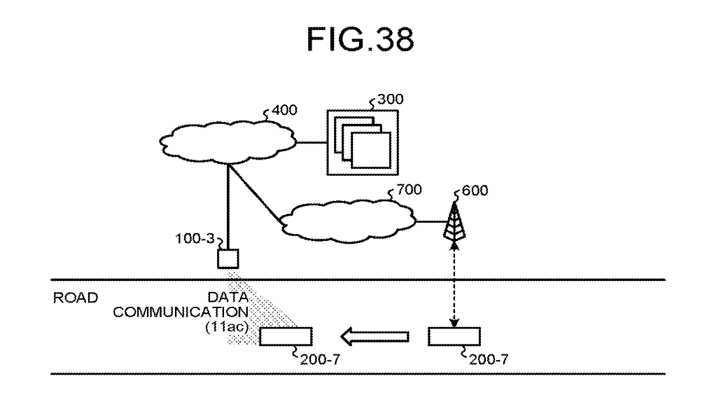

FIG. 38 is a diagram illustrating an exemplary overall configuration of a communication system according to a fourth modification example. As illustrated in FIG. 38, the communication system according to the fourth modification example includes the AP 100-3, an in-vehicle device 200-7, the server 300, the network 400, the base station 600, and the cellular network 700.

The in-vehicle device 200-7 has the function of performing communication via the cellular network 700 for the purpose of preliminary setup communication, and has the function of performing wireless communication at a relatively high speed (such as IEEE 802.11ac) for the purpose of data communication.

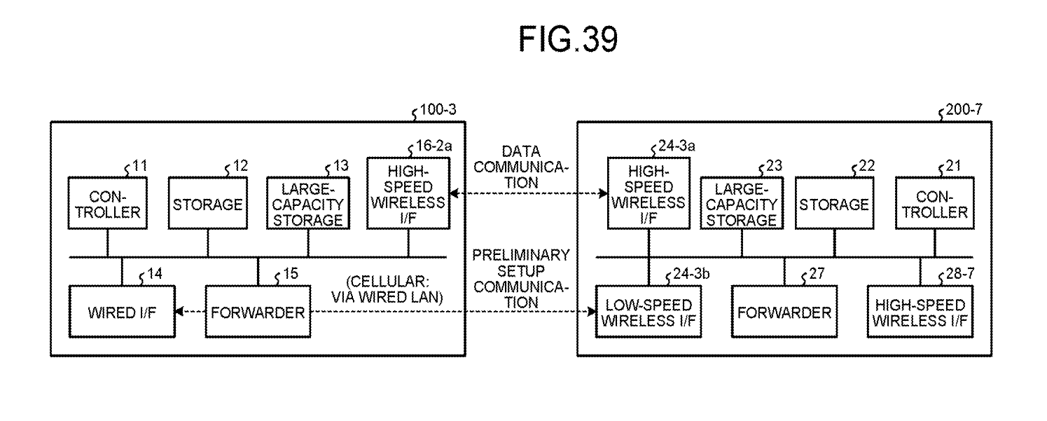

FIG. 39 is a diagram illustrating an exemplary hardware configuration of the in-vehicle device 200-7. As illustrated in FIG. 39, the in-vehicle device 200-7 includes the controller 21, the storage 22, the large-capacity storage 23, a high-speed wireless I/F 24-3a, a low-speed wireless I/F 24-3b, the forwarder 27, and a high-speed wireless I/F 28-7.

The high-speed wireless I/F 28-7 is an interface for performing wireless communication with the devices present inside the vehicle. Herein, the high-speed wireless I/F 28-7 is an interface based on the IEEE 802.11ac standard considered for high-speed data communication.

### Fifth Modification Example

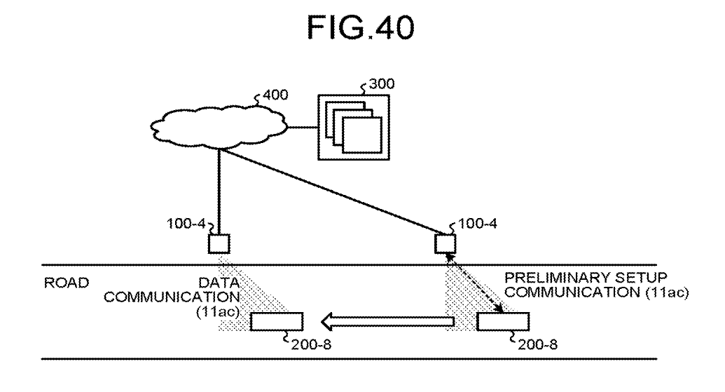

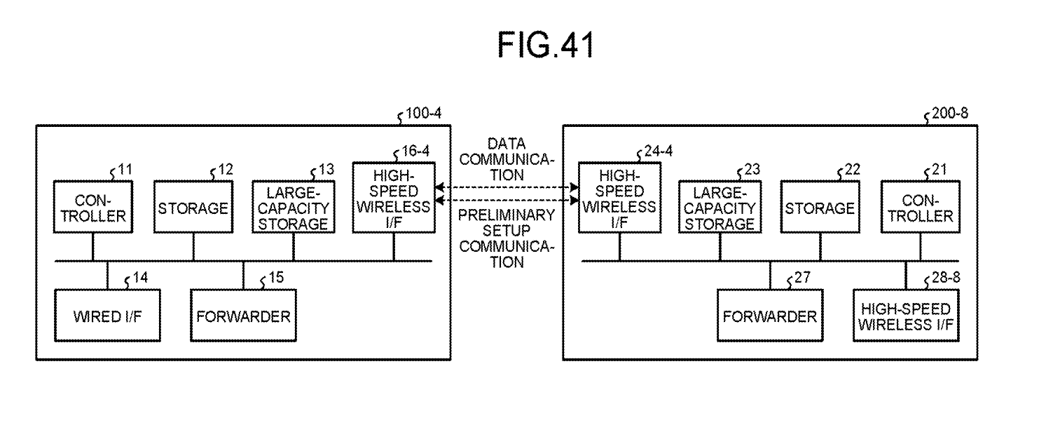

FIG. 40 is a diagram illustrating an exemplary overall configuration of a communication system according to a fifth modification example. As illustrated in FIG. 40, the communication system according to the fifth modification example includes the AP 100-4, an in-vehicle device 200-8, the server 300, and the network 400.

The in-vehicle device 200-8 has the function of performing wireless communication at a relatively high speed (such as IEEE 802.11ac) for the purpose of preliminary setup communication and data communication.

FIG. 40 is a diagram illustrating an exemplary hardware configuration of the in-vehicle device 200-8. As illustrated in FIG. 40, the in-vehicle device 200-8 includes the controller 21, the storage 22, the large-capacity storage 23, the high-speed wireless I/F 24-4, the forwarder 27, and a high-speed wireless I/F 28-8.

The high-speed wireless I/F 28-8 is an interface for performing wireless communication with the devices present inside the vehicle. Herein, the high-speed wireless I/F 28-8 is an interface based on the IEEE 802.11ac standard considered for high-speed data communication.

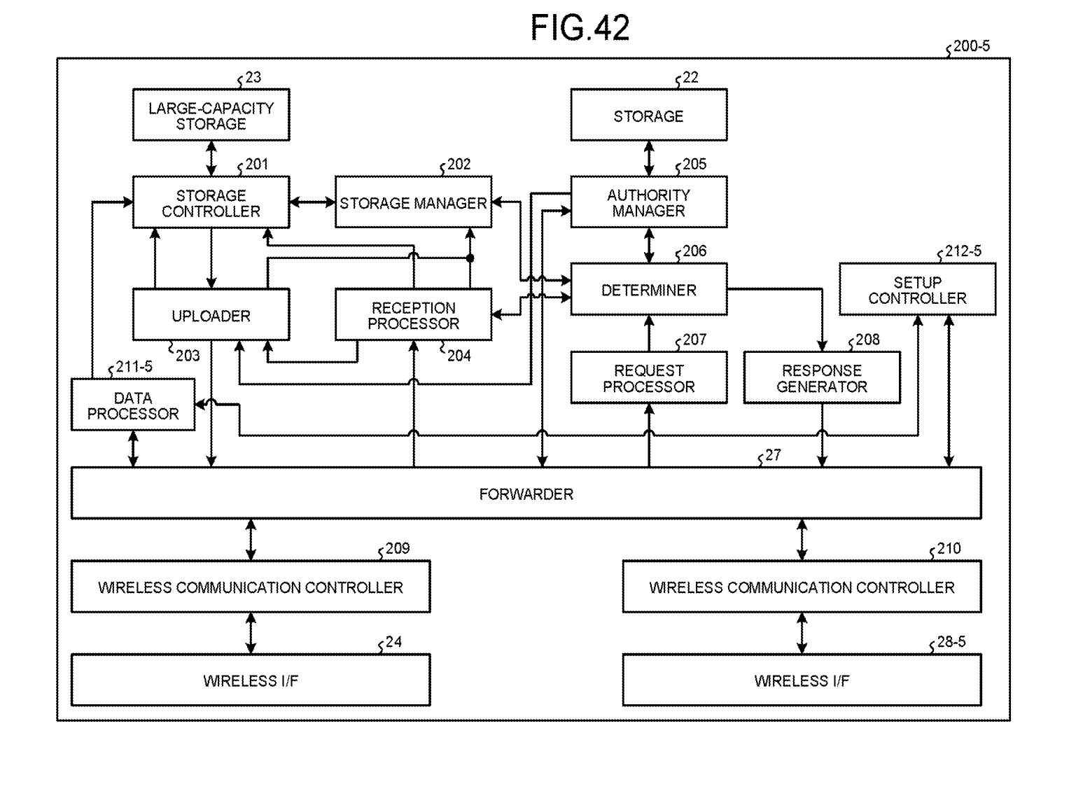

Given below is the explanation of an exemplary functional configuration of the in-vehicle device 200-5 according to the fifth embodiment. FIG. 42 is a block diagram illustrating an exemplary functional configuration of the in-vehicle device 200-5. As illustrated in FIG. 42, the in-vehicle device 200-5 includes the storage 22, the large-capacity storage 23, the wireless I/F 24, the forwarder 27, the wireless I/F 28-5, a storage controller 201, a storage manager 202, an uploader 203, a reception processor 204, an authority manager 205, a determiner 206, a request processor 207, a response generator 208, a wireless communication controller 209, a wireless communication controller 210, a data processor 211-5, and a setup controller 212-5.

The storage controller 201, the storage manager 202, the uploader 203, the reception processor 204, the authority manager 205, the determiner 206, the request processor 207, and the response generator 208 have identical functions to the storage controller 101, the storage manager 102, the uploader 103, the reception processor 104, the authority manager 105, the determiner 106, the request processor 107, and the response generator 208, respectively.

The wireless communication controller 209 controls the relay between the wireless I/F 24 and the forwarder 27. The wireless communication controller 210 controls the relay between the wireless I/F 28-5 and the forwarder 27. For example, each of the wireless communication controllers 209 and 210 is implemented using a device driver or firmware.

The data processor 211-5 collects information generated by sensors and applications present inside the vehicle in which the in-vehicle device 200-5 is installed, and stores the collected information in the large-capacity storage 23, for example. Some of the information having a high degree of secrecy can be stored in a storage having a high level of independence (not illustrated). The information can be collected via the wireless I/F 28-5, or can be directly collected from a sensor.

Examples of the information stored in the large-capacity storage 23 include:

### (1) Vehicle-Specific Information

registration number

manufacturer

chassis number

software version

### (2) Driving Information

running distance

operation information, operation history, and operation features related to vehicle equipment (such as the accelerator and the brake)

speed

acceleration

remaining fuel, remaining oil, and remaining battery

status of in-vehicle announcements

opening-closing status of doors

information related to number of people in vehicle and baggage (number of people, number of pieces of baggage, and weight)

### (3) Intermediate Data

intermediate processing data of image data recorded using in-vehicle camera

### (4) Others

current location information

temperature and humidity on inside and outside of vehicle

brightness

sound volume

air pressure

When a predetermined condition is satisfied, the data processor 211-5 requests the setup controller 212-5 to start an information sending operation. Examples of the condition used by the data processor 211-5 include a condition in which the volume of information stored in the large-capacity storage 23 reaches a predetermined volume and a condition of having a predetermined time interval.

Moreover, for example, during the preliminary setup, when an operation (such as compression) with respect to the data to be sent (the transmission information) is requested from the setup controller 212-5, the data processor 211-5 performs data processing according to the request.

The setup controller 212-5 performs the preliminary setup with the AP 100. Herein, the setup controller 212-5 performs the operations according to the sequence of the preliminary setup as described in the earlier embodiments. The setup controller 212-5 performs the preliminary setup upon receiving a request from the data processor 211-5. During the process of preliminary setup, if an operation (such as compression) with respect to the transmission information is requested, the setup controller 212-5 notifies the data processor 211-5 about that request.

Meanwhile, in each modification example (the third to fifth modification examples), if each added interface is connected to the forwarder 27 via the corresponding communication controller, then the remaining configuration is identical to the configuration illustrated in FIG. 42. Thus, the detailed explanation is not repeated.

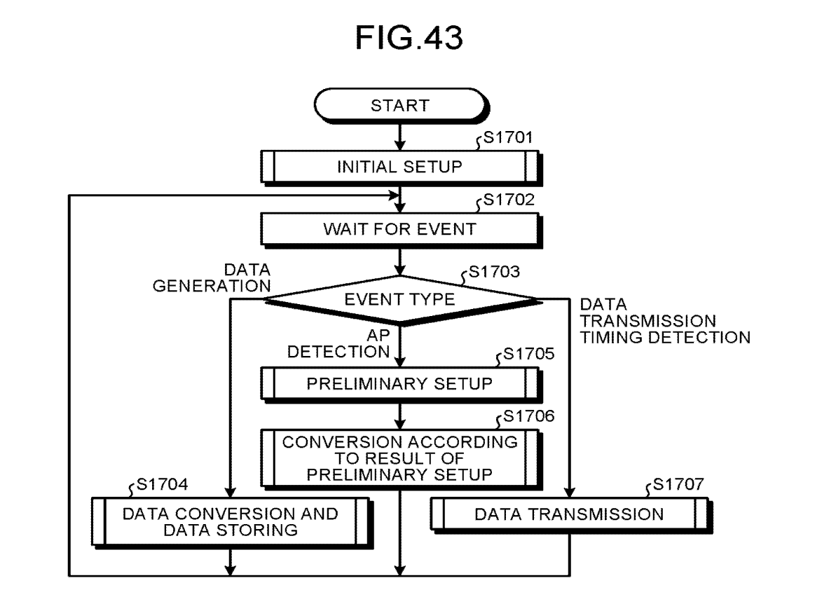

Explained below with reference to FIG. 43 is a communication operation performed by the in-vehicle device 200-5 configured in the abovementioned manner according to the fifth embodiment. FIG. 43 is a sequence diagram for explaining an example of the communication operation performed by the in-vehicle device 200-5 according to the fifth embodiment.

The data processor 211-5 performs initial setup (Step S1701). The details of the initial setup are given later. Then, the data processor 211-5 waits for an event (Step S1702).

Examples of an event include a data generation event, an AP detection event, and a data transmission timing detection event. The data generation event indicates that data (information) such as transmission information has been generated. The AP detection event indicates that the AP 100 has been detected because of approaching it. The data transmission timing detection event indicates that a predetermined condition for sending transmission information has been satisfied.

The data processor 211-5 determines the type of the event (Step S1703). In the case of the data generation event (data generation at Step S1703), the data processor 211-5 performs data conversion and data storing according to an instruction (Step S1704). For example, the data processor 211-5 performs operations according to an instruction for conversion or storing of the data notified as a result of the initial setup and the data notified during the subsequently-performed preliminary setup.

If any rules for conversion and storing are changed during the preliminary setup, then those rules can be stored in the storage 22 and can be applied at the time of sending the next set of data (i.e., not applied to the data to be sent during the preliminary setup as decided, but applied to the data to be sent in the next instance).

When the event is an AP detection event (AP detection at Step S1703), the data processor 211-5 instructs the setup controller 212-5 to perform the preliminary setup (Step S1705). During the preliminary setup, if a request for conversion of transmission information is received from the AP 100 or the server 500, then the data processor 211-5 performs the instructed operation with respect to the transmission information to be sent (Step S1706). Regarding the data generated during the period of time starting from the start of conversion to the transmission, the data processor 211-5 performs conversion according to the rules stored at Step S1704.

If the event is a data transmission timing detection event (data transmission timing detection at Step S1703), then the data processor 211-5 performs a transmission operation to send the data (the transmission information) that is stored in the large-capacity storage 23, for example, (Step S1707). For example, the data processor 211-5 reads data from a storage (such as the large-capacity storage 23), and sequentially performs communication protocol handling and transmission via a wireless network.

Given below is the explanation about the initial setup. Herein, the initial setup represents operations, such as adjusting the volume of stored information and preprocessing of information, that are performed by the in-vehicle device 200-5 before sending the information.

During the initial setup, the manner of handling the generated data (i.e., the data granularity for storing and the data granularity during calculations) is determined. For example, if there are many transmission opportunities (if the transmission frequency is high) during the anticipated travel, then a large volume of data can be sent. Hence, the accuracy of information can be enhanced, and a large volume of data can be stored. On the other hand, if there are only a few transmission opportunities during the anticipated travel, then only a small volume of data can be sent. Hence, the data selected with the focus on important information can be stored.

Whether or not a transmission opportunity is present can be understood by recording the following information during the travel: the transmission opportunities (the transmission frequency), the volume of transmitted data, the volume of data that is not transmitted (the volume of non-transmitted data), the volume of generated data, and the rate of compression of the generated data. Moreover, in cooperation with the car navigation, the number of APs 100 can be found out and the transmission opportunities can be estimated.

The result of the initial setup can be notified from the in-vehicle device 200-5 to the AP 100 or the server 500 at the timing of performing the preliminary setup. The device that receives the notification can adjust the frequency of receiving the transmission information based on the received information. For example, the received information can be used in determining whether or not to accept transmission information. After performing determination regarding the notified result, the AP 100 or the server 500 can send the determination-based changed result back to the in-vehicle device 200-5. Meanwhile, if the result of preliminary setup communication specifies an access point, such as a wireless LAN access point in a home or an office, that enables communication of a large volume of data without any trouble; then more detailed information can be sent regardless of the result of the initial setup or the preliminary setup.

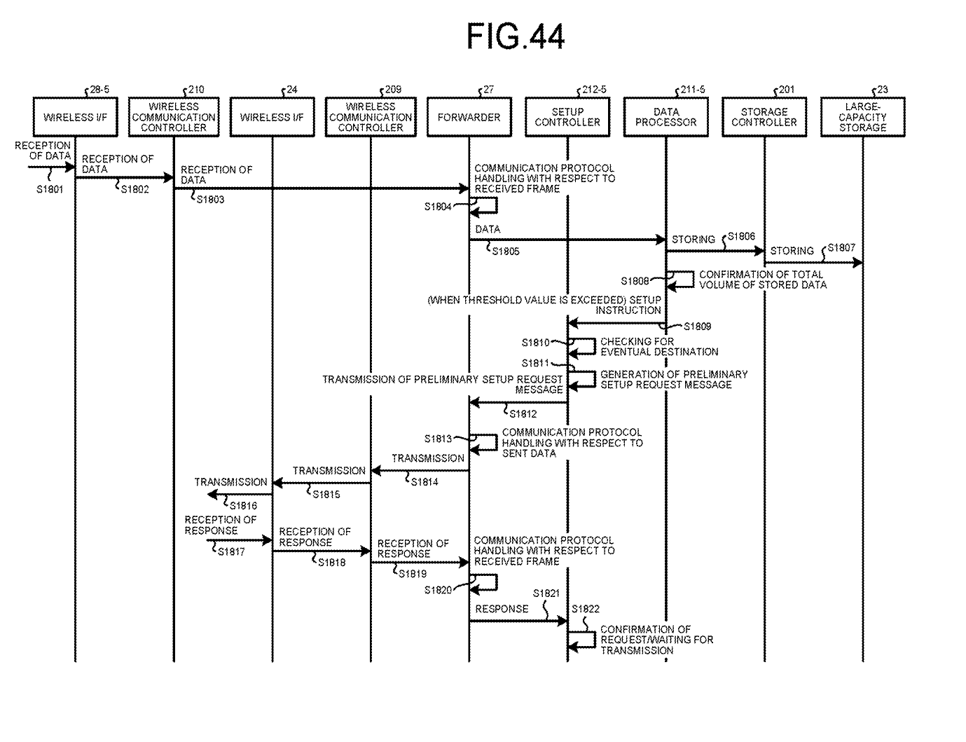

Explained below with reference to FIG. 44 is a communication operation performed by the in-vehicle device 200-5 configured in the abovementioned manner according to the fifth embodiment. FIG. 44 is a diagram illustrating a sequence diagram for explaining an example of the communication operation performed by the in-vehicle device 200-5 according to the fifth embodiment.

The wireless I/F 28-5 receives data from a device present inside the vehicle and sends the data to the forwarder 27 via the wireless communication controller 210 (Steps S1801 to S1803). Then, the forwarder 27 performs communication protocol handling with respect to the received frame (Step S1804), and sends the received data to the data processor 211-5 (Step S1805).

The data processor 211-5 stores the received data in the large-capacity storage 23 via the storage controller 201 (Steps S1806 and S1807). The data processor 211-5 confirms the size (the total volume of the stored data (Step S1908). If the total volume exceeds a predetermined threshold value, then the data processor 211-5 instructs the setup controller 212-5 to start the preliminary startup (Step S1809).

The setup controller 212-5 checks for the final destination (for example, the server 300) of the data (the transmission information) (Step S1810). Moreover, the setup controller 212-5 generates a preliminary setup request message (Step S1811) and sends it to the forwarder 27 (Step S1812).

The forwarder 27 performs communication protocol handling with respect to the sent data (the preliminary setup request) (Step S1813), and sends the post-communication-protocol-handling data to the wireless communication controller 209 and the wireless I/F 24 (Steps S1814 to S1816).

Then, the forwarder 27 receives a response with respect to the sent data via the wireless I/F 24 and the wireless communication controller 209 (Steps S1817 to S1819).

Subsequently, the forwarder 27 performs communication protocol handling with respect to the received frame (Step S1820). Then, the forwarder 27 sends the received response to the setup controller 212-5 (Step S1821).

The setup controller 212-5 checks for the response and waits until transmission of the next set of data (Step S1822). For example, the setup controller 212-5 waits until attaining the state enabling data transmission and starts the transmission when it is confirmed that the condition (the radio field strength) is satisfied. The necessary information related to the condition is appropriately collected using the wireless I/F 28-5.

In this way, in the fifth embodiment, as a result of installing a large-capacity storage in the in-vehicle device too, the information generated inside the vehicle can be temporarily stored and then sent. Hence, it becomes possible to collectively send the information that is generated bit by bit, thereby enabling the transmission of information in a more efficient manner.

### Sixth Embodiment

In the first to fifth embodiments, when an in-vehicle device is the sender of information and sends information to a destination server via an AP, the attention is given to securing resources of the AP and establishing a communication channel. In a sixth embodiment, the explanation is given for an opposite case in which a server is the sender of information and sends information to a destination in-vehicle device via an AP.

One of the implementation methods is to interchange the role of the in-vehicle device and the server in the earlier embodiments. For example, the server sends a preliminary setup request to the AP, and the AP determines whether the resources can be allocated. If the resources can be allocated, then the AP sends transmission information, which is received from the server and stored in a storage, to the in-vehicle device. In another implementation, the AP sends a preliminary setup request to the in-vehicle device, and the in-vehicle device determines whether the resources can be allocated. If the resources can be allocated, then the AP sends transmission information, which is received from the server and stored in a storage, to the in-vehicle device. The following explanation is given mainly for the second implementation method.

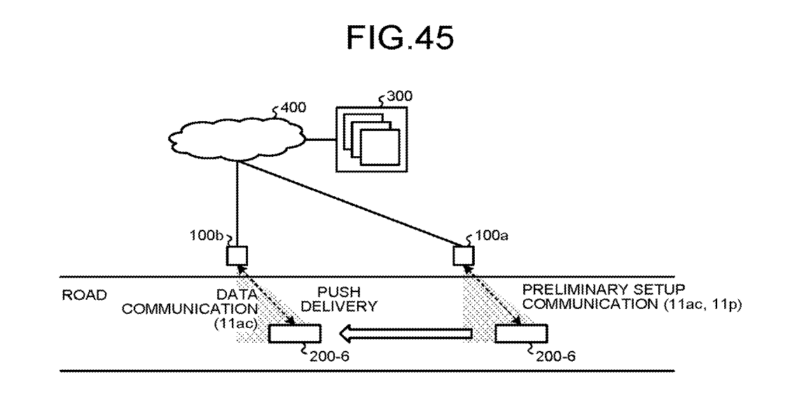

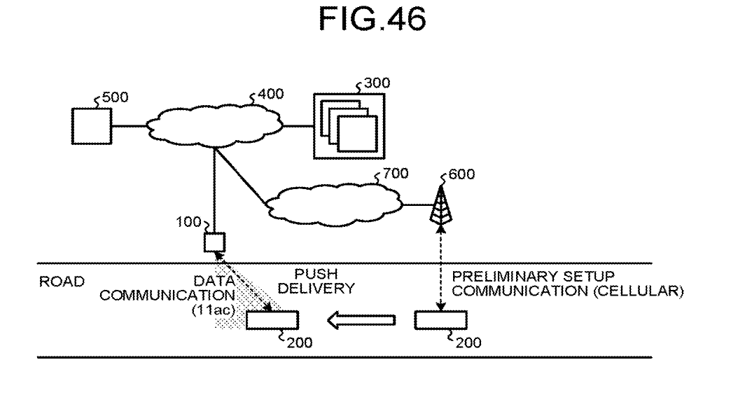

Herein, the in-vehicle device and the AP can have a hardware configuration according to any one of the earlier embodiments. Explained below with reference to FIGS. 45 and 46 are two exemplary configurations.

FIG. 45 is a diagram illustrating an exemplary overall configuration of a communication system according to the sixth embodiment. As illustrated in FIG. 45, the communication system according to the sixth embodiment includes APs 100a and 100b, the in-vehicle device 200-6, the server 300, and the network 400.

When the in-vehicle device 200-6 and the AP 100a are in a mutually communicable state, a preliminary setup request is sent from the AP 100a to the in-vehicle device 200-6. When the resources can be allocated, information is pushed to the in-vehicle device 200 from the AP 100b that is approached next.

FIG. 46 is a diagram illustrating another exemplary overall configuration of the communication system according to the sixth embodiment. As illustrated in FIG. 46, the communication system according to the sixth embodiment includes the AP 100, the in-vehicle device 200, the server 300, the network 400, the server 500, the base station 600, and the cellular network 700.

The in-vehicle device 200 is detected via the cellular network 700, and a preliminary setup request is sent to the in-vehicle device 200 via the cellular network 700. When the resources can be allocated, information is pushed to the in-vehicle device 200 from the AP 100.

In this way, in the sixth embodiment, the AP 100 sends a resource allocation request to the in-vehicle device 200, and the in-vehicle device 200 determines whether sufficient resources for communication can be allocated. Meanwhile, the in-vehicle device 200 (the in-vehicle device 200-6) can have an identical configuration to that illustrated in FIG. 42, for example.

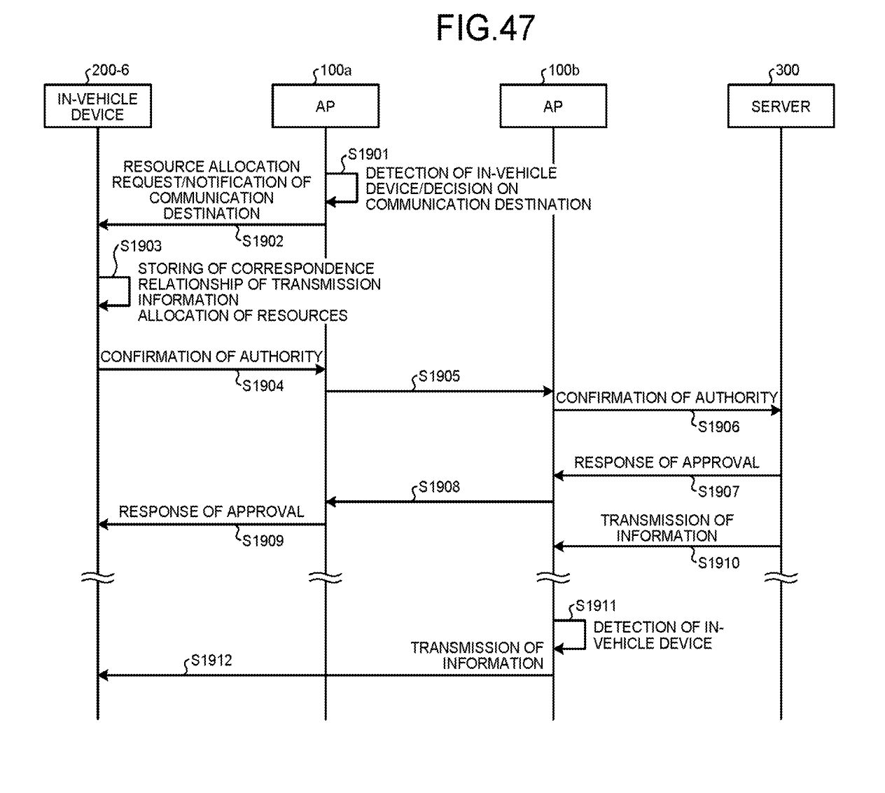

FIG. 47 is a sequence diagram for explaining an example of the communication operation according to the sixth embodiment. In FIG. 47 is illustrated an example of a configuration in which the concerned AP 100 determines the AP 100 (the communication destination) that performs push delivery.

When the in-vehicle device 200-6 is detected, the AP 100a determines the AP 100 (the communication destination) that would communicate with the detected in-vehicle device 200-6 (Step S1901). The AP 100a sends a resource allocation request and a notification about the communication destination to the in-vehicle device 200-6 (Step S1902).

Upon receiving the resource allocation request, the in-vehicle device 200-6 stores the correspondence relationship of the transmission information in the large-capacity storage 23, and determines whether resource allocation is possible (Step S1903).

In the case of using authority resources as the resources, the in-vehicle device 200-6 confirms the authority with the server 300 via the AP 100a and the AP 100b that represents the communication destination (Steps S1904 to S1906). The server 300 sends a response with respect to authority confirmation to the in-vehicle device 200-6 (Steps S1907 to S1909). Meanwhile, with reference to FIG. 47, the server 300 is assumed to be the generator of the information to be sent. The server 300 sends transmission information to the AP 100b (Step S1910).

The AP 100b representing the communication destination detects the in-vehicle device 200-6 (Step S1911), and starts sending transmission information to the in-vehicle device 200-6 (Step S1912). Meanwhile, the server 300 can send transmission information to the AP 100b at any point of time prior to performing the operation at Step S1911. Since the server 300 sends transmission information in advance to the AP 100b, the transmission information can be delivered to the in-vehicle device 200-6 in a swift manner.

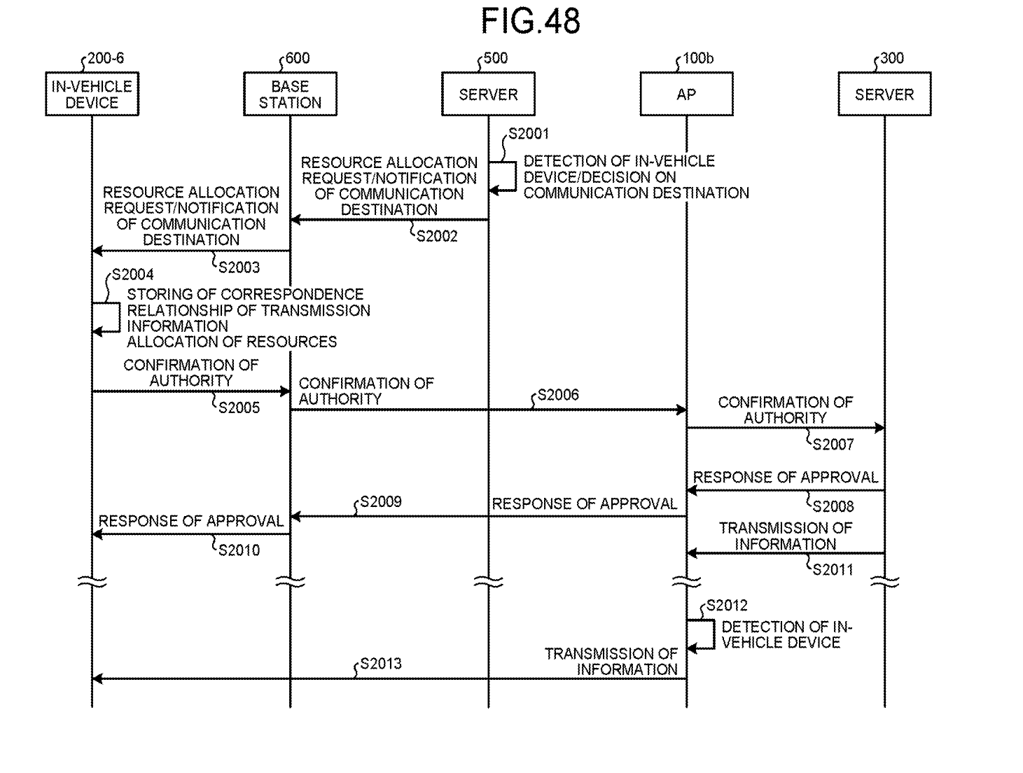

FIG. 48 is a sequence diagram for explaining another example of the communication operation according to the sixth embodiment. In FIG. 48 is illustrated an example of a configuration in which the concerned AP 100 requests the server 500 to determine the AP 100 (the communication destination) that performs push delivery.

The server 500 detects the in-vehicle device 200-6 representing the information destination based on the information to be sent, and determines the AP 100 (the communication destination) that would communicate with the detected in-vehicle device 200-6 (Step S2001). The server 500 sends a resource allocation request and a notification about the communication destination to the in-vehicle device 200-6 via the base station 600 (Steps S2002 and S2003).

The subsequent operations performed from Steps S2004 to S2013 are identical to the operations performed from Steps S1903 to S1912 illustrated in FIG. 47.

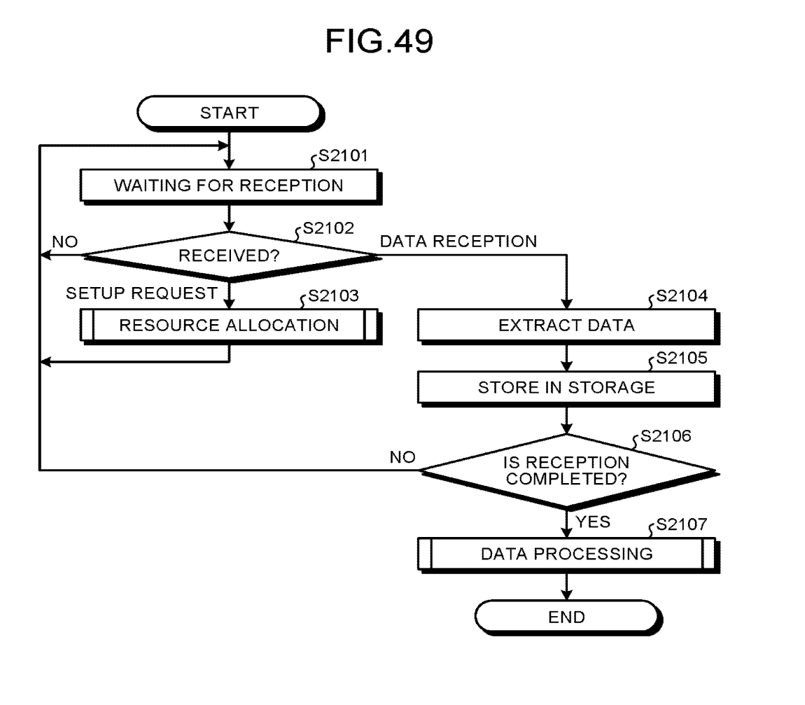

FIG. 49 is a flowchart for explaining an example of the communication operation performed by the in-vehicle device 200-6 according to the sixth embodiment.

In the in-vehicle device 200-6, the request processor 207 and the reception processor 204 wait for the reception of a preliminary setup request or transmission information (Step S2101). The forwarder 27 determines whether or not a preliminary setup request or a transmission request for sending transmission information is received (Step S2102). If no request is received (No at Step S2102), the forwarder 27 waits until receiving a request. Herein, as described earlier, whether or not a preliminary setup request or a transmission request is received is determined by referring to the IP address, the port number, the communication protocol, and the message body as may be necessary.

When a preliminary setup request is received (setup request at Step S2102), the request processor 207 analyzes the preliminary setup request and the determiner 206 performs a resource allocation operation for determining whether or not the resources can be allocated (Step S2103). The resource allocation operation can be performed in an identical manner to that explained in the earlier embodiments. When the resources could be allocated, the system control returns to Step S2101 and the reception of transmission information is awaited.

Meanwhile, at Step S2102, when a transmission request for sending transmission information is received (data reception at Step S2102), the forwarder 27 extracts transmission information from the received transmission request (Step S2104). The reception processor 204 stores the extracted transmission information in a storage (Step S2105). Then, the reception processor 204 determines whether or not all sets of transmission information have been received (Step S2106). If all sets of transmission information have not been received (No at Step S2106), the system controls returns to Step S2101 and the operations are repeated.

When all sets of transmission information are received (Yes at Step S2106), the in-vehicle device 200-6 performs data processing according to the transmission information (Step S2107). The data processing is dependent on the individual applications that make use of the transmission information. For example, the data processing includes displaying the received information or playing the receiving information as sound.

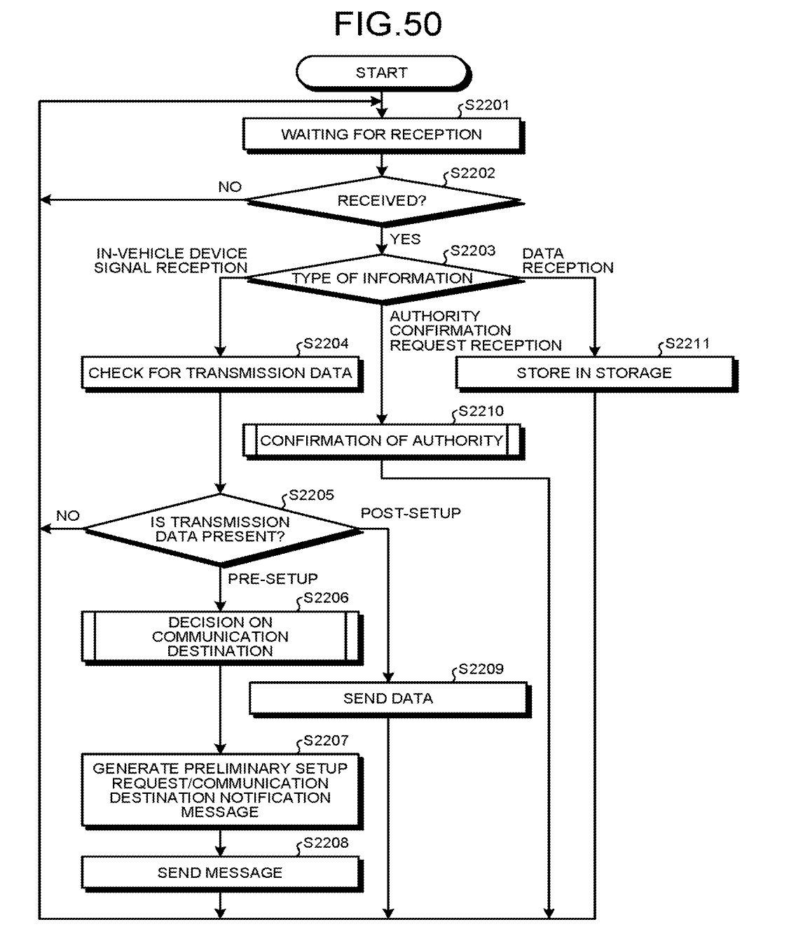

FIG. 50 is a flowchart for explaining an example of the communication operation performed by the AP 100 according to the sixth embodiment.

In the AP 100, the request processor 107 and the reception processor 104 wait for reception of data (a signal) (Step S2201). The forwarder 15 determines whether or not data (a signal) is received (Step S2202). If data (a signal) is not received (No at Step S2202), reception is awaited.

When the data (a signal) is received (Yes at Step S2202), the forwarder 15 determines the type of the received data (the received signal) (Step S2203). For example, the forwarder 15 determines whether the received data represents an in-vehicle device signal, or an authority confirmation request, or data reception. As described earlier, that determination is performed by referring to the IP address, the port number, the communication protocol, and the message body as may be necessary.

The in-vehicle device signal represents information sent and received between the AP 100 and the in-vehicle device 200 for the purpose of recognizing the presence of each other. For example, a beacon can be used as the in-vehicle device signal. The authority confirmation request represents information that is receivable during an authority transfer operation performed while securing the resources in the in-vehicle device 200. The data reception represents information in the case of receiving information in advance from the server 300. Meanwhile, sending and receiving of such information is performed independently of the communication between the AP 100 and the in-vehicle device 200.

When an in-vehicle device signal is received (in-vehicle device signal reception at Step S2203), the request processor 107 checks for the transmission data to be sent from the in-vehicle device 200 (Step S2204). Herein, the request processor 107 determines whether or not the transmission data is present and determines the type of the transmission data (whether pre-setup data or post-setup data) (Step S2205).

When transmission data is not present (No at Step S2205), then the system control returns to Step S2201 and data reception is awaited. When the transmission data indicates pre-setup data (pre-setup at Step S2205), the request processor 107 determines the AP 100 representing the communication destination that would communicate with the in-vehicle device 200 (Step S2206). The determination of the communication destination can be done in an identical manner to the method for determining the transfer destination explained in the earlier embodiments.

The response generator 108 generates a preliminary setup request and a message notifying the determined communication destination (Step S2207). Then, the request processor 107 sends the generated message (the preliminary setup request and the communication destination notification message) to the in-vehicle device 200 (Step S2208).

If the transmission data indicates post-setup data (post-setup at Step S2205), the request processor 107 sends the transmission information to the in-vehicle device 200 (Step S2209).

Meanwhile, at Step S2203, when an authority confirmation request is received (authority confirmation request reception at Step S2203), the authority manager 105 performs authority confirmation with the server 300 (Step S2210).

Alternatively, when the transmission information is received at Step S2203 (data reception at Step S2203), the request processor 107 stores the received transmission information in the large-capacity storage 13 via the storage controller 101 (Step S2211).

In this way, in the communication device according to the sixth embodiment, even in the case in which a server is the sender and sends information to an in-vehicle device via an AP, it becomes possible to implement the same functions as the functions according to the first to fifth embodiments.

As described above, according to the first to sixth embodiments, the communication between a terminal device, a communication device, and a server device can performed in a stable manner.

Meanwhile, computer programs executed in the devices (the communication device, the terminal device, and the server device) according to the embodiments described above are stored in advance in the ROM 52.

Alternatively, the computer programs executed in the embodiments described above can be recorded as installable or executable files in a computer-readable recording medium such as a compact disk read only memory (CD-ROM), a flexible disk (FD), a compact disk recordable (CD-R), or a digital versatile disk (DVD); and can be provided as a computer program product.

Still alternatively, the computer programs executed in the embodiments described above can be saved as downloadable files on a computer connected to a network such as the Internet or can be made available for distribution through a network such as the Internet.

The computer programs executed in the embodiments described above can make a computer function as the constituent elements of the devices. In the computer, a control device such as a CPU can read the computer programs from a computer-readable storage medium, load them into a main storage device, and execute them.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device connectable to a portable terminal device and a server device, the communication device comprising:
a storage configured to store information transmitted and received between the terminal device and the server device;
a wireless communication controller configured to control wireless communication with the terminal device;
a request processor configured to receive a request to perform communication between the terminal device and the server device via the communication device, the request being transmitted from at least one of the terminal device and the server device;
a determiner configured to determine whether a resource required for the requested communication is allocatable;
a response generator configured to generate a response indicating a determination result obtained by the determiner; and
a communication controller configured to store information received from one of the terminal device and the server device in the storage, and transmit information read from the storage to the other device.

2. The device according to claim 1, wherein the resource represents at least one of a storage area of the storage, a communication channel established between the terminal device and the communication device and between the communication device and the server device, volume of data communicable using the communication channel, and authority enabling the communication device to transfer information using the communication channel.

3. The device according to claim 1, further comprising a communication controller configured to control the communication performed using the resource when the resource is determined to be allocatable.

4. The device according to claim 1, wherein
the resource represents a storage area of a storage,
the determiner, when determining that the storage area is not allocatable, further calculates a period of time taken for the storage area to become allocatable, and
the response generator generates a response notifying the calculated period of time.

5. The device according to claim 1, wherein
the resource represents a storage area of a storage,
the determiner further compares a first size which represents a size of information transmitted and received in the requested communication with a second size that represents a size of information that is deletable from the storage, and
the determiner, when the first size is greater than the second size, deletes the deletable information from the storage and determines that a resource required for the communication is allocatable.

6. The device according to claim 1, wherein
the resource represents a storage area of a storage, and
the response generator further generates a response for requesting an operation to reduce a size of information transmitted and received in the requested communication when the storage area is determined not to be allocatable.

7. The device according to claim 1, wherein the response generator further generates a response for requesting transfer of information that is transmitted and received in the requested communication to another terminal device.

8. The device according to claim 1, wherein
the determiner further determines a transmission timing for information to be transmitted in the requested communication, and
the response generator further generates a response notifying the transmission timing.

9. The device according to claim 1, wherein the wireless communication controller further controls wireless communication with the server device.

10. The device according to claim 1, further comprising:
a first communication interface for performing wireless communication with the terminal device; and
a second communication interface, wherein
the wireless communication controller controls wireless communication performed via the first communication interface, and
the request processor receives the request for the communication via the second communication interface.

11. The device according to claim 1, wherein
the request processor receives a request for the communication transferred from an external device that has received the request for the communication from the terminal device, and
the response generator generates the response to be transmitted to the terminal device via the external device with respect to the request for the communication transferred from the external device.

12. The device according to claim 1, wherein
the determiner further determines whether to perform communication between the terminal device and the server device via an external device, and
the communication device further comprises a forwarder configured to transfer the request for the communication to the external device when the communication between the terminal device and the server device is determined to be performed via the external device.

13. The device according to claim 12, wherein the determiner further determines the external device that relays communication between the terminal device and the server device, based on at least one of speed of the terminal device or a mobile object including the terminal device, attribute information of the terminal device or a mobile object including the terminal device, number of requested communication instances, and a characteristic of information to be transmitted.

14. A terminal device connectable to a server device via a communication device, the terminal device comprising:
a wireless communication controller configured to control wireless communication with the communication device;
a storage configured to store information; and
a data processor configured to transmit a request to perform communication between the terminal device and the server device via the communication device to the communication device when a predetermined condition regarding the information is satisfied.

15. The device according to claim 14, wherein the data processor processes information that is to be transmitted during communication with the server device, based on at least one of volume of transmission data, volume of non-transmission data, volume of generated data, and compression rate of generated data.

16. A communication system comprising:
a portable terminal device;
a server device; and
a communication device, wherein
the terminal device includes a data processor configured to transmit a request to perform communication between the terminal device and the server device via the communication device to the communication device, and
the communication device includes
a wireless communication controller configured to control wireless communication with the terminal device,
a storage configured to store information transmitted and received between the terminal device and the server device,
a request processor configured to receive a request to perform communication between the terminal device and the server device via the communication device,
a determiner configured to determine whether a resource required for the requested communication is allocatable,
a response generator configured to generate a response indicating a determination result obtained by the determiner, and
a communication controller configured to store information received from one of the terminal device and the server device in the storage, and transmit information read from the storage to the other device.
